(19) United States
(12) Patent Application Publication
(10) Pub. No.: US 2024/0080675 A1
(43) Pub. Date: Mar. 7, 2024

(54) METHOD FOR PERFORMING NETWORK CONTROL IN WIRELESS COMMUNICATIONS SYSTEM, AND ASSOCIATED APPARATUS

(71) Applicant: MEDIATEK INC., Hsin-Chu (TW)

(72) Inventors: Hsin-Chun Huang, Hsinchu City (TW); Po-Chun Fang, Hsinchu City (TW); Tsung-Jung Lee, Hsinchu City (TW); Ray-Kuo Lin, Hsinchu City (TW)

(73) Assignee: MEDIATEK INC., Hsin-Chu (TW)

(21) Appl. No.: 18/230,187

(22) Filed: Aug. 4, 2023

Related U.S. Application Data
(60) Provisional application No. 63/374,261, filed on Sep. 1, 2022.

(51) Int. Cl. H04W 16/02; H04W 52/24

(52) U.S. Cl. CPC H04W 16/02; H04W 52/241

(57) ABSTRACT

A method for performing network control in a wireless communications system and associated apparatus are provided. The method may include: carrying a set of link information in a preamble of a first data transmission frame transmitted from the first network device to a second network device, wherein the set of link information may include at least one indication among the following indications: a destination device indication, a device assignment indication and a transmission power control indication; wherein a third network device is arranged to monitor wireless transmission in the wireless communications system to obtain the set of link information from the first data transmission frame, and determine spatial reuse (SR) transmission availability of the third network device based on the set of link information.

### CROSS REFERENCE TO RELATED APPLICATIONS

This application claims the benefit of U.S. Provisional Application No. 63/374,261, filed on Sep. 1, 2022. The content of the application is incorporated herein by reference.

### BACKGROUND

The present invention is related to communications control, and more particularly, to a method for performing network control in a wireless communications system, and associated apparatus such as an access point (AP) device and a station (STA) device.

According to the related art, a wireless communications system comprising a first AP device, a second AP device, etc. may be configured as a mesh network. Based on channel planning, co-channel interference (CCI) may exist when two or more links among various links (e.g., fronthaul and backhaul links) in the mesh network are arranged to use the same channel. For example, in order to prevent any CCI, when one device is transmitting a first packet via a certain channel, another device may need to wait until completion of the transmission of the first packet, and transmit a second packet via this channel afterward, causing overall performance to be degraded. As the other device may make a wrong decision to operate improperly, the one device may need to re-transmit the first packet via this channel due to the CCI, causing overall performance to be degraded. Thus, a novel method and associated architecture are needed for solving the problem of the related art without introducing any side effect or in a way that is less likely to introduce a side effect.

### SUMMARY

It is an objective of the present invention to provide a method for performing network control in a wireless communications system, and associated apparatus such as an AP device and a STA device, in order to solve the above-mentioned problem.

It is another objective of the present invention to provide a method for performing network control in a wireless communications system, and associated apparatus such as an AP device and a STA device, in order to mitigate or eliminate the CCI in the mesh network with aid of spatial reuse (SR)-related control such as SR scheduling and SR power control.

At least one embodiment of the present invention provides a method for performing network control in a wireless communications system, where the wireless communications system comprises a first network device, a second network device and a third network device. For example, the method may comprise: carrying a set of link information in a preamble of a first data transmission frame transmitted from the first network device to the second network device, wherein the set of link information comprises at least one indication among the following indications: a destination device indication, a device assignment indication and a transmission power control indication; wherein the third network device is arranged to monitor wireless transmission in the wireless communications system to obtain the set of link information from the first data transmission frame, and determine SR transmission availability of the third network device based on the set of link information.

In addition to the method mentioned above, the present invention further provides the second network device that operates according to the method, where the second network device may comprise: a processing circuit, arranged to control operations of the second network device; and at least one communications control circuit, coupled to the processing circuit, arranged to perform communications control, wherein the at least one communications control circuit is arranged to perform wireless communications operations with the first network device for the second network device. For example, the second network device may be arranged to receive the first data transmission frame carrying the set of link information in the preamble and correctly process the first data transmission frame, without being hindered by any SR transmission performed by the third network device to another network device with respect to the first data transmission frame.

At least one embodiment of the present invention provides a first network device for performing network control in a wireless communications system, where the wireless communications system comprises the first network device, a second network device and a third network device, and the first network device may comprise: a processing circuit, arranged to control operations of the first network device; and at least one communications control circuit, coupled to the processing circuit, arranged to perform communications control, wherein the at least one communications control circuit is arranged to perform wireless communications operations with the second network device for the first network device. For example, the first network device may be arranged to carry a set of link information in a preamble of a first data transmission frame transmitted from the first network device to the second network device, wherein the set of link information comprises at least one indication among the following indications: a destination device indication, a device assignment indication and a transmission power control indication; and the third network device may be arranged to monitor wireless transmission in the wireless communications system to obtain the set of link information from the first data transmission frame, and determine SR transmission availability of the third network device based on the set of link information.

At least one embodiment of the present invention provides a method for performing network control in a wireless communications system, where the wireless communications system comprises a first network device, a second network device and a third network device. For example, the method may comprise: monitoring wireless transmission in the wireless communications system to obtain a set of link information from a preamble of a first data transmission frame, wherein the first network device is arranged to carry the set of link information in the preamble of the first data transmission frame transmitted from the first network device to the second network device, wherein the set of link information comprises at least one indication among the following indications: a destination device indication, a device assignment indication and a transmission power control indication; and determining SR transmission availability of the third network device based on the set of link information.

In addition to the method mentioned above, the present invention further provides the third network device that operates according to the method, where the third network device may comprise: a processing circuit, arranged to control operations of the third network device; and at least one communications control circuit, coupled to the processing circuit, arranged to perform communications control, wherein the at least one communications control circuit is arranged to perform wireless communications operations with another network device in the wireless communications system for the third network device. For example, the second network device may be arranged to receive the first data transmission frame carrying the set of link information in the preamble and correctly process the first data transmission frame, without being hindered by any SR transmission performed by the third network device to the other network device (e.g., the aforementioned another network device) with respect to the first data transmission frame.

According to some embodiments, the first data transmission frame may be a physical layer (PHY) protocol data unit (PPDU), and the preamble may be the PHY preamble of the PPDU. For example, the aforementioned at least one indication may be carried in at least one field in the PHY preamble, and the aforementioned at least one field may comprise one or a combination of an SR field and another field in the PHY preamble. More particularly, both of the device assignment indication and the transmission power control indication may be integrated into an encoded indication carried by a predetermined field (e.g., either the SR field or the other field) in the PHY preamble.

It is an advantage of the present invention that, through proper design, the present invention method, as well as the associated apparatus such as any device among the first network device, the second network device and the third network device, can enhance the overall performance of the wireless communications system. For example, the present invention method and the associated apparatus can mitigate or eliminate the CCI in the mesh network with aid of SR-related control such as SR scheduling and SR power control, and more particularly, maintain coordination of multiple AP devices to prevent the associated performance from degrading. In addition, the present invention method and apparatus can solve the related art problem without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communications system according to an embodiment of the present invention.

FIG. 2 is a diagram illustrating a mesh control scheme according to an embodiment of the present invention.

FIG. 3 is a diagram illustrating a Wi-Fi-6-based SR control scheme according to an embodiment of the present invention.

FIG. 4 is a diagram illustrating associated information needed in the Wi-Fi-6-based SR control scheme shown in FIG. 3.

FIG. 5 is a diagram illustrating an SR initialization control scheme of a method for performing network control in a wireless communications system according to an embodiment of the present invention.

FIG. 6 is a diagram illustrating a far-client-check control scheme of the method according to an embodiment of the present invention.

FIG. 7 is a diagram illustrating a shared-AP assigning control scheme of the method according to an embodiment of the present invention.

FIG. 8 is a diagram illustrating an SR-STA selecting control scheme of the method according to an embodiment of the present invention.

FIG. 9 is a diagram illustrating an SR power control scheme of the method according to an embodiment of the present invention.

FIG. 10 is a diagram illustrating an SR rate selection control scheme of the method according to an embodiment of the present invention.

FIG. 11 is a diagram illustrating a sharing-AP timing and packet error rate (PER) calculation control scheme of the method according to an embodiment of the present invention.

FIG. 12 is a diagram illustrating a shared-AP timing and SR-request maintaining control scheme of the method according to an embodiment of the present invention.

FIG. 13 is a diagram illustrating a selective airtime-sharing and SR power control scheme of the method according to an embodiment of the present invention.

FIG. 14 is a diagram illustrating a first PPDU format involved with the method according to an embodiment of the present invention.

FIG. 15 is a diagram illustrating a second PPDU format involved with the method according to an embodiment of the present invention.

FIG. 16 illustrates a working flow of the method according to an embodiment of the present invention.

FIG. 17 illustrates a working flow of the method according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

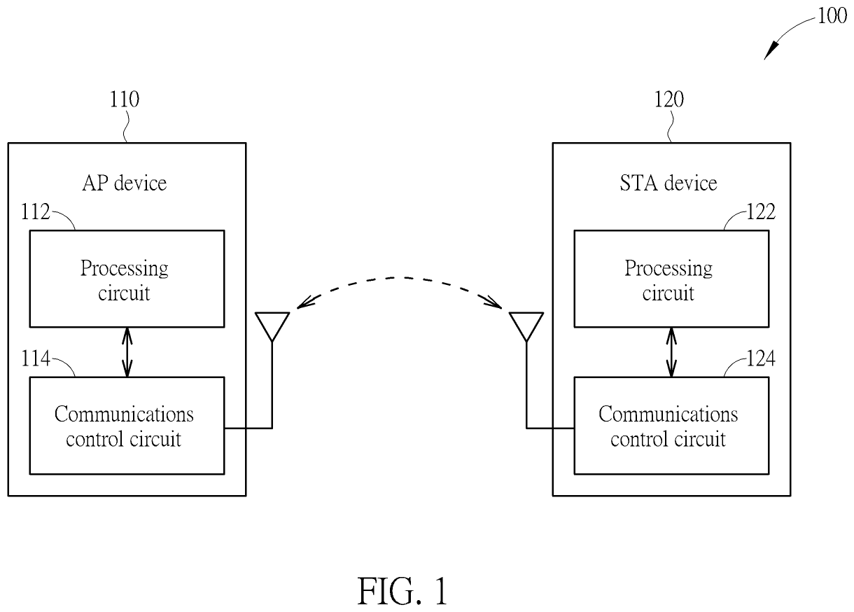

FIG. 1 is a diagram of a wireless communications system 100 according to an embodiment of the present invention. For better comprehension, the wireless communications system 100 (e.g., any device therein) may be compatible or back-compatible to one or more versions of the Institute of Electrical and Electronics Engineers (IEEE) 802.11 standards, but the present invention is not limited thereto. As shown in FIG. 1, the wireless communications system 100 may comprise multiple wireless communications devices such as the AP device 110 and the STA device 120, where the AP device 110 may comprise a processing circuit 112, at least one communications control circuit (e.g., one or more communications control circuits), which may be collectively referred to as the communications control circuit 114, and at least one antenna (e.g., one or more antennas) of the communications control circuit 114, and the STA device 120 may comprise a processing circuit 122, at least one communications control circuit (e.g., one or more communications control circuits), which may be collectively referred to as the communications control circuit 124, and at least one antenna (e.g., one or more antennas) of the communications control circuit 124. In the architecture shown in FIG. 1, the processing circuit 112 can be arranged to control operations of the AP device 110 to make the AP device 110 act as an AP in the wireless communications system 100, and the communications control circuit 114 can be arranged to perform communications control, and more particularly, perform wireless communications operations with another device such as the STA device 120 (or the communications control circuit 124 thereof) for the AP device 110. In addition, the processing circuit 122 can be arranged to control operations of the STA device 120 to make the STA device 120 act as an STA in the wireless communications system 100, and the communications control circuit 124 can be arranged to perform communications control, and more particularly, perform wireless communications operations with another device such as the AP device 110 (or the communications control circuit 114 thereof) for the STA device 120.

Regarding the architecture of the AP device 110, the processing circuit 112 can be implemented by way of at least one processor/microprocessor, at least one random access memory (RAM), at least one bus, etc., and the communications control circuit 114 can be implemented by way of at least one wireless network control circuit and at least one wired network control circuit, but the present invention is not limited thereto. Regarding the architecture of the STA device 120, the processing circuit 122 can be implemented by way of at least one processor/microprocessor, at least one RAM, at least one bus, etc., and the communications control circuit 124 can be implemented by way of at least one wireless network control circuit, but the present invention is not limited thereto.

According to some embodiments, the wireless communications system 100 may comprise multiple AP devices and multiple STA devices. For example, there may be M AP devices and N STA devices in the wireless communications system 100, and the AP device count M and the STA device count N may be positive integers that are greater than one, respectively. The multiple AP devices may comprise the AP devices {110_m|m=0, . . . , (M−1)} such as the AP devices {110_0, . . . , 110_(M−1)}, and the multiple STA devices may comprise the STA devices {120_n|n=0, . . . , (N−1)} such as the STA devices {120_0, . . . , 120_(N−1)}, where the symbol “m” may be an integer in the interval [0, M], and the symbol “n” may be an integer in the interval [0, N], but the present invention is not limited thereto. In addition, the architecture of any AP device 110_m (e.g., each AP device) among the AP devices {110_0, . . . , 110_(M−1)} may be the same as or similar to the architecture of the AP device 110, and the architecture of any STA device 120_n (e.g., each STA device) among the STA devices {120_0, . . . , 120_(N−1)} may be the same as or similar to the architecture of the STA device 120. For brevity, similar descriptions for these embodiments are not repeated in detail here.

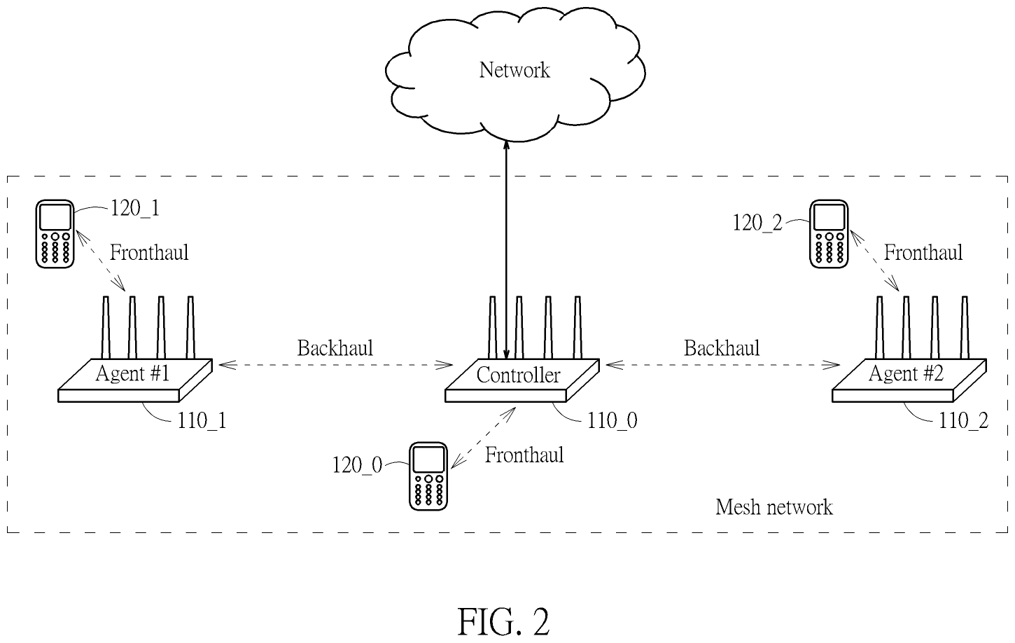

FIG. 2 is a diagram illustrating a mesh control scheme according to an embodiment of the present invention, where the multiple AP devices may comprise the AP devices 110_0, 110_1 and 110_2, and the multiple STA devices may comprise the STA devices 120_0, 120_1 and 120_2. As shown in FIG. 2, the wireless communications system 100 comprising the multiple AP devices such as the AP devices 110_0, 110_1 and 110_2 and the multiple STA devices such as the STA devices 120_0, 120_1 and 120_2 may be configured as a mesh network, but the present invention is not limited thereto. According to some embodiments, the mesh architecture shown in FIG. 2, the AP device count M and/or the STA device count N may vary. For example, the STA device count N may be a positive integer.

In the mesh architecture shown in FIG. 2, when a first AP node such as the AP device 110_0 in the wireless communications system 100 is connected to at least one network (e.g., one or more networks) such as the Internet with a wide area network (WAN) port, the first AP node such as the AP device 110_0 may act as a controller of the mesh network, and one or more other AP nodes (e.g., the AP devices 110_1 and 110_2) associated to the controller may act as one or more agents of the mesh network. For better comprehension, the AP devices 110_1 and 110_2 may act as the agents #1 and #2 of the mesh network, respectively, but the present invention is not limited thereto. As shown in FIG. 2, the links between the devices may comprise backhaul links and fronthaul links (respectively labeled “Backhaul” and “Fronthaul” for brevity). The mesh AP nodes (e.g., the first AP node and the one or more other AP nodes in the mesh network) such as the AP devices 110_0, 110_1 and 110_2 may exchange information and data through the backhaul links. In addition, the mesh AP nodes such as the AP devices 110_0, 110_1 and 110_2 may communicate with STAs such as the STA devices 120_0, 120_1 and 120_2 through the fronthaul links, respectively. For example, all of the fronthaul links may be wireless fronthaul links, and the backhaul links may comprise wired and/or wireless backhaul links, but the present invention is not limited thereto. In some examples, all of the backhaul links may be wireless backhaul links.

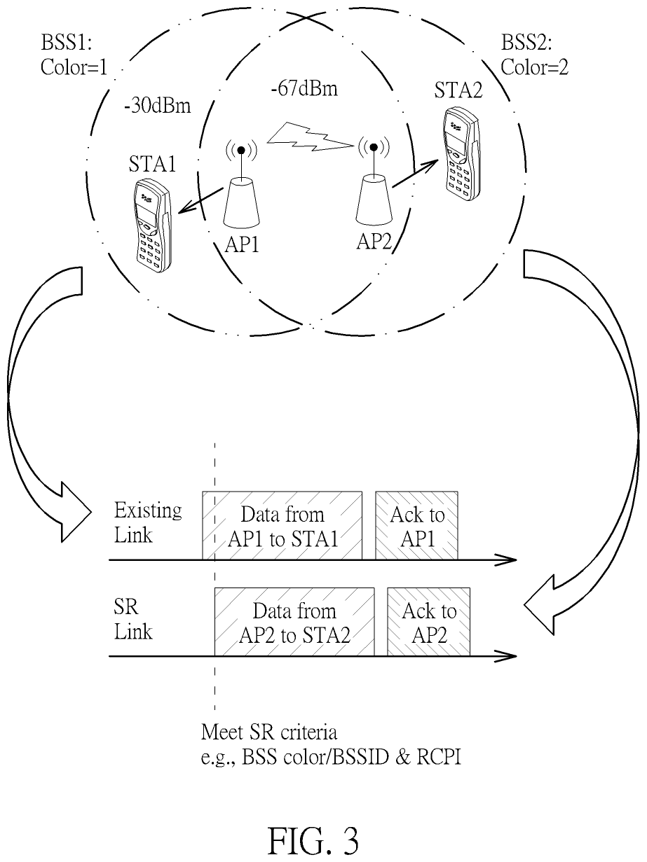

FIG. 3 is a diagram illustrating a Wi-Fi-6-based SR control scheme according to an embodiment of the present invention. For better comprehension, assume that the wireless communications system 100 may operate according to the Wi-Fi-6-based SR control scheme, where the AP devices 110_0 and 110_1 among the multiple AP devices may act as two APs AP1 and AP2 corresponding to two basic service sets (BSSs) BSS1 and BSS2, respectively, and the STA devices 120_0 and 120_1 among the multiple STA devices may act as two STAs STA1 and STA2, but the present invention is not limited thereto. In an existing link between the AP AP1 and the STA STA1, the AP AP1 may send data from the AP AP1 to the STA STA1, and the STA STA1 may send an acknowledgement (Ack) to the AP AP1. The associated traffic may meet predetermined SR criteria (e.g., related to a BSS color or BSS identifier (BSSID), and a received channel power indicator (RCPI)). In this situation, in an SR link, the AP AP2 may send data from the AP AP2 to the STA STA2, and the STA STA2 may send an Ack to the AP AP2.

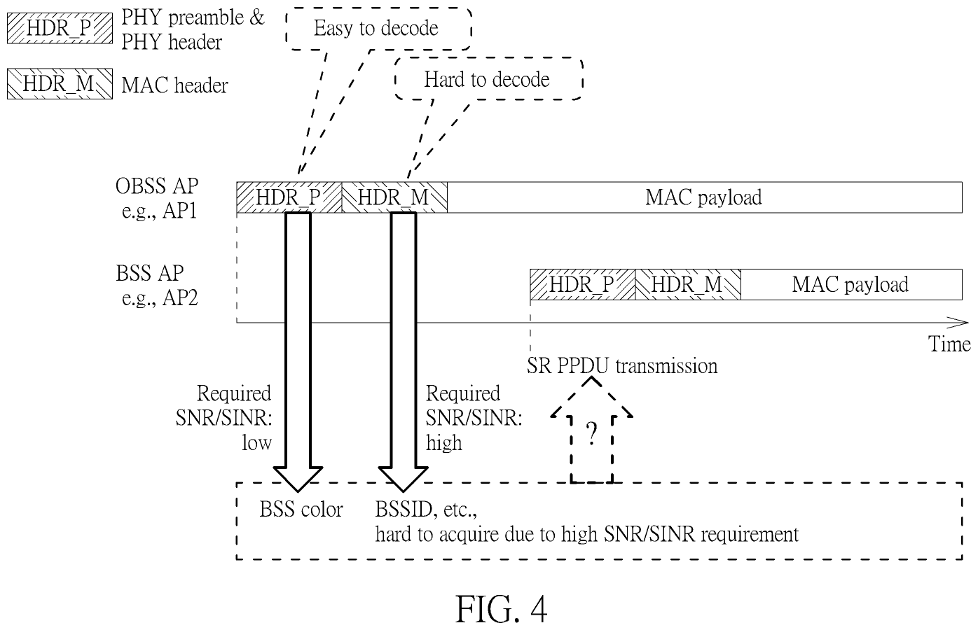

FIG. 4 is a diagram illustrating associated information needed in the Wi-Fi-6-based SR control scheme shown in FIG. 3. For a certain BSS AP such as the AP AP2, a PHY preamble and a PHY header (labeled “HDR_P” for brevity) of a PPDU sent from an overlapping BSS (OBSS) AP such as the AP AP1 may be easy to decode, but a medium access control (MAC) header (labeled “HDR_M” for brevity) of the PPDU sent from the OBSS AP such as the AP AP1, as well as the associated MAC payload in the PPDU, may be hard to decode, where this PPDU is not intended to be sent to the AP AP2 and the power level of this PPDU is typically insufficient for the AP AP2. For example, the required signal-to-noise ratio (SNR) or signal-to-interference-plus-noise ratio (SINR) for decoding the PHY preamble and the PHY header of the PPDU is low, so the AP AP2 may successfully decode the PHY preamble of the PPDU to obtain a BSS color from the PHY preamble of this PPDU. In addition, the required SNR or SINR for decoding the MAC header of the PPDU is high, so it is hard for the AP AP2 to successfully decode the MAC header of the PPDU to obtain a BSSID, etc. from the MAC header of this PPDU. Before determining whether to perform an SR PPDU transmission, the AP AP2 needs to obtain sufficient information from the PPDU sent from the AP AP1. As the BSSID, etc. in the MAC header of the PPDU is hard to acquire due to the high SNR/SINR requirement, the AP AP2 typically does not have sufficient information for the determination (labeled “?” in FIG. 4 for brevity), and it is hard for the AP AP2 to operate correctly in this situation.

Typically, the Wi-Fi-6-based SR control scheme does not work in any mesh architecture. The Wi-Fi-6-based SR control scheme may only consider an AP-to-AP received signal strength indicator (RSSI), without considering any SINR or PER at any STA, which may cause unwanted interference at the STA and increase the PER at the STA. For example, in a hidden node case, when the AP device 110_0 is sending data to the STA device 120_0, two or more other AP devices such as the AP devices 110_1 and 110_2 may be unable to hear from each other due to hidden nodes, and may perform SR transmission at the same time. For another example, in a known node case, when the AP device 110_0 is sending data to the STA device 120_0, two or more other AP devices such as the AP devices 110_1 and 110_2 may be unable to hear from each other due to low SINRs, and may perform SR transmission at the same time. In a situation where there is no SR scheduling, the Wi-Fi-6-based SR control scheme may lead to SR collisions (e.g., two or more APs such as the AP devices 110_1 and 110_2 perform SR transmission at the same time), cause unwanted interference at the STA, and increase the PER at the STA. As shown in the following embodiments, the present invention provides an enhanced SR mechanism for performing SR scheduling and SR power control, to allow the mesh devices to correctly make decision regarding SR transmission (TX) availability and properly control the SR transmission power, where the present invention method and the associated apparatus can mitigate or eliminate the CCI in the mesh network with aid of SR-related control such as SR scheduling and SR power control, and more particularly, maintain SR transmission with a well-controlled transmission power and avoid occurrence of any SR collision.

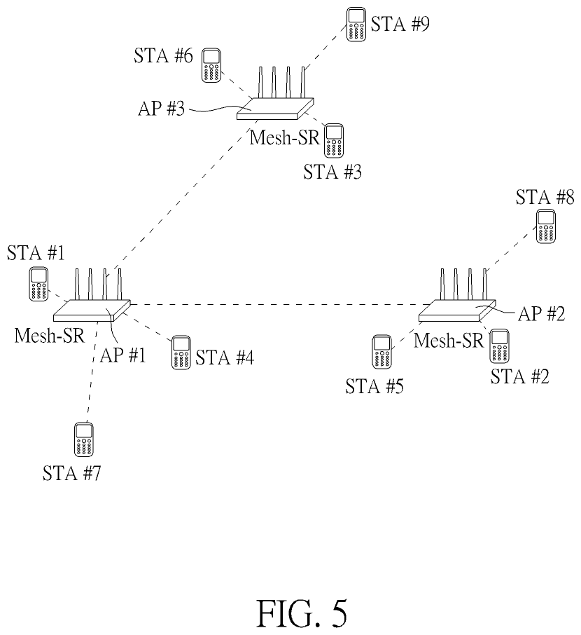

FIG. 5 is a diagram illustrating an SR initialization control scheme of a method for performing network control in a wireless communications system such as the wireless communications system 100 according to an embodiment of the present invention. The wireless communications system 100 may be configured as a mesh network, and multiple devices in the wireless communications system 100, such as the multiple AP devices (e.g., the AP devices {110_0, . . . , 110_(M−1)}) and the multiple STA devices (e.g., the STA devices {120_0, . . . , 120_(N−1)}), may be regarded as multiple network devices such as multiple mesh devices. The method is applicable to any device among the multiple network devices, such as a first network device, a second network device, a third network device, etc. For example, the multiple network devices may operate according to the method to enhance SR transmission power control and airtime sharing efficiency. For better comprehension, assuming that M=3 and N=9, the AP devices {110_0, . . . , 110_(M−1)} and the STA devices {120_0, . . . , 120_(N−1)} may act as the APs #1, #2 and #3 and the STAs #1, #2, #3, #4, #5, #6, #7, #8 and #9 in the mesh architecture shown in FIG. 5, respectively, but the present invention is not limited thereto. According to some embodiments, the mesh architecture shown in FIG. 5, the AP device count M and/or the STA device count N may vary. For example, the STA device count N may be a positive integer.

In an initial stage such as Stage #0, the APs #1, #2 and #3 may exchange the respective information thereof such as their identifiers (IDs), supported features, SR requests, etc. to organize a mesh network where each AP among the APs #1, #2 and #3 may share the airtime with any other AP among the APs #1, #2 and #3 to allow the other AP to perform SR transmission (labeled “Mesh-SR” for brevity). For example, an AP that shares the airtime to the aforementioned any other AP while performing normal transmission may be referred to as the sharing AP, and the other AP involved with SR transmission may be referred to as the shared AP. In addition, an STA that receives a data transmission frame such as a PPDU from the sharing AP may be referred to as the sharing STA, and another STA that receives another data transmission frame such as another PPDU from the shared AP may be referred to as the shared STA.

At any time point when the first network device is transmitting a data transmission frame such as a PPDU to the second network device, the first network device, the second network device and the third network device may represent a frame-transmitting device acting as a sharing AP (e.g., the AP #1), a frame-receiving device acting as a sharing STA (e.g., a certain STA among the STAs #1, #4 and #7) and an SR-scheduling-aware-frame-transmitting device acting as a shared AP (e.g., the AP #2), respectively, but the present invention is not limited thereto. The first network device such as the AP #1 may be arranged to transmit multiple first data transmission frames (e.g., multiple first PPDUs) to the STAs #1, #4 and #7, respectively, the second network device such as a certain STA among the STAs #1, #4 and #7 may be arranged to receive one of the multiple first data transmission frames from the first network device such as the AP #1, and the third network device such as the AP #2 may be arranged to monitor the multiple first data transmission frames to determine whether to perform an SR transmission operation. For example, operations of the first network device, the second network device and the third network device may comprise:
(1) the first network device (e.g., the AP #1) may carry a first set of link information in a first preamble (e.g., a PHY preamble) of a first data transmission frame (e.g., a first PPDU among the multiple first PPDUs) transmitted from the first network device to the second network device, where the first set of link information may comprise at least one indication such as a destination device indication, a device assignment indication and a transmission power control indication, for indicating a target network device (e.g., a target shared AP) which is allowed to perform SR transmission and the way of controlling the associated SR transmission power, respectively;
(2) the second network device (e.g., the aforementioned certain STA among the STAs #1, #4 and #7) may receive the first data transmission frame (e.g., the first PPDU) carrying the first set of link information in the first preamble (e.g., the PHY preamble) and correctly process the first data transmission frame, without being hindered by any SR transmission performed by the third network device to another network device with respect to the first data transmission frame; and
(3) the third network device (e.g., the AP #2) may monitor wireless transmission in the wireless communications system 100 to obtain the first set of link information from the first preamble (e.g., the PHY preamble) of the first data transmission frame (e.g., the first PPDU), and determine SR transmission availability of the third network device based on the first set of link information; where the device assignment indication may be configured as a device identifier (ID) such as the ID of the target shared AP (e.g., one of the APs #2 and #3), for indicating which network device is the target network device allowed to perform the SR transmission, and the transmission power control indication may be configured as an SR transmission power control indicator, for indicating a predetermined candidate power control setting selected from multiple predetermined candidate power control settings regarding SR transmission power control, but the present invention is not limited thereto. For example, if the multiple first data transmission frames indicate that the third network device (e.g., the AP #2) is allowed to perform SR transmission, respectively, the third network device may transmit multiple second data transmission frames (e.g., multiple second PPDUs) to the STAs #2, #5 and #8, respectively. In response to any of the multiple first data transmission frames indicating that the third network device is allowed to perform SR transmission, the third network device may transmit a second data transmission frame (e.g., a second PPDU among the multiple second PPDUs) to any other network device (e.g., one of the STAs #2, #5 and #8) with controlled power. In addition, the aforementioned at least one indication may be carried in at least one field (e.g., one or more fields) in the PHY preamble, and the aforementioned at least one field may comprise one or a combination of an SR field and another field in the PHY preamble. For example, the other field may be a reserved field in a certain version among multiple versions of the IEEE 802.11 standards, but the present invention is not limited thereto.

TABLE 1

| Value | Meaning |
|---|---|
| 0 | PSR_DISALLOW |
| 1-12 | Reserved |
| 13 | SR_RESTRICTED |
| 14 | SR_DELAYED |
| 15 | PSR_AND_NON_SRG_OBSS_PD_PROHIBITED |

TABLE 2

| Value | Meaning |
|---|---|
| 0 | PSR_DISALLOW |
| 1-12 | ID_AND_SR_TX_Power_Control |
| 13 | SR_RESTRICTED |
| 14 | SR_DELAYED |
| 15 | PSR_AND_NON_SRG_OBSS_PD_PROHIBITED |

Table 1 illustrates an example of a set of predetermined candidate values in the SR field of the PHY preamble, and Table 2 illustrates another example of the same set of predetermined candidate values with the previously reserved values 1-12 being named as the ID and SR transmission power control parameter ID_AND_SR_TX_Power_Control, where the set of predetermined candidate values (labeled “Value” for brevity) may be collectively referred to as the SR-field value Spatial_Reuse. The parameters PSR_DISALLOW, SR_RESTRICTED, SR_DELAYED and PSR_AND_NON_SRG_OBSS_PD_PROHIBITED may be defined in at least one version of the IEEE 802.11 standards, and the ID and SR transmission power control parameter ID_AND_SR_TX_Power_Control may be arranged to carry the aforementioned at least one indication, but the present invention is not limited thereto. In some examples, the other field (i.e., the aforementioned another field in the PHY preamble) may be arranged to comprise the ID and SR transmission power control parameter ID_AND_SR_TX_Power_Control for carrying the aforementioned at least one indication.

Some implementation details regarding the aforementioned at least one indication may be further described as follows. According to some embodiments, the third network device may determine the SR transmission availability based on the device assignment indication. For example, the device assignment indication may be arranged to indicate a network device selected from other network devices by the first network device, such as a selected network device that is scheduled to perform SR transmission with respect to the first data transmission frame. If the selected network device is equal to the third network device, the third network device may perform the SR transmission with respect to the first data transmission frame; otherwise, the third network device is prevented from performing any SR transmission operation with respect to the first data transmission frame. In addition, the third network device may control the SR transmission power based on the transmission power control indication. For example, the transmission power control indication may be arranged to indicate whether to adjust the SR transmission power. If the transmission power control indication indicates that adjusting the SR transmission power is requested, the third network device may configure the SR transmission power to correspond to a first predetermined power value instead of a default power value; otherwise, the third network device may configure the SR transmission power to correspond to the default power value.

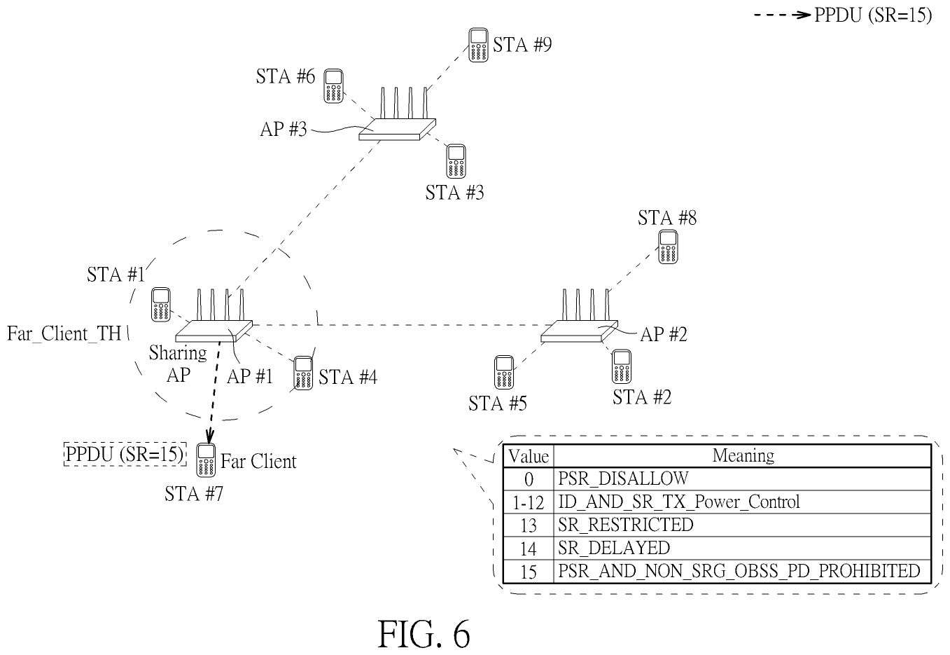

FIG. 6 is a diagram illustrating a far-client-check control scheme of the method according to an embodiment of the present invention. In Stage #1, the sharing AP such as the AP #1 may mark a downlink PPDU (e.g., a PPDU transmitted from the AP #1 to the STA #7) as SR prohibited if the RSSI of the downlink STA (e.g., the STA #7) is lower than a far-client threshold Far_Client_TH. More particularly, the AP #1 may mark the downlink PPDU as SR prohibited by setting the SR-field value Spatial_Reuse in the SR field of the PHY preamble of the downlink PPDU to be the parameter PSR_AND_NON_SRG_OBSS_PD_PROHIBITED (e.g., Spatial_Reuse=15). As shown in FIG. 6, the STA #7 (or the center thereof) may be positioned outside the circle corresponding to the far-client threshold Far_Client_TH, indicating that the RSSI of the STA #7 is lower than the far-client threshold Far_Client_TH at this moment, and therefore the STA #7 may be regarded as a far client. In response to the RSSI of the STA #7 being lower than the far-client threshold Far_Client_TH, the sharing AP such as the AP #1 may mark the downlink PPDU as SR prohibited by setting Spatial_Reuse=15 in the downlink PPDU (labeled “PPDU (SR=15)” for brevity).

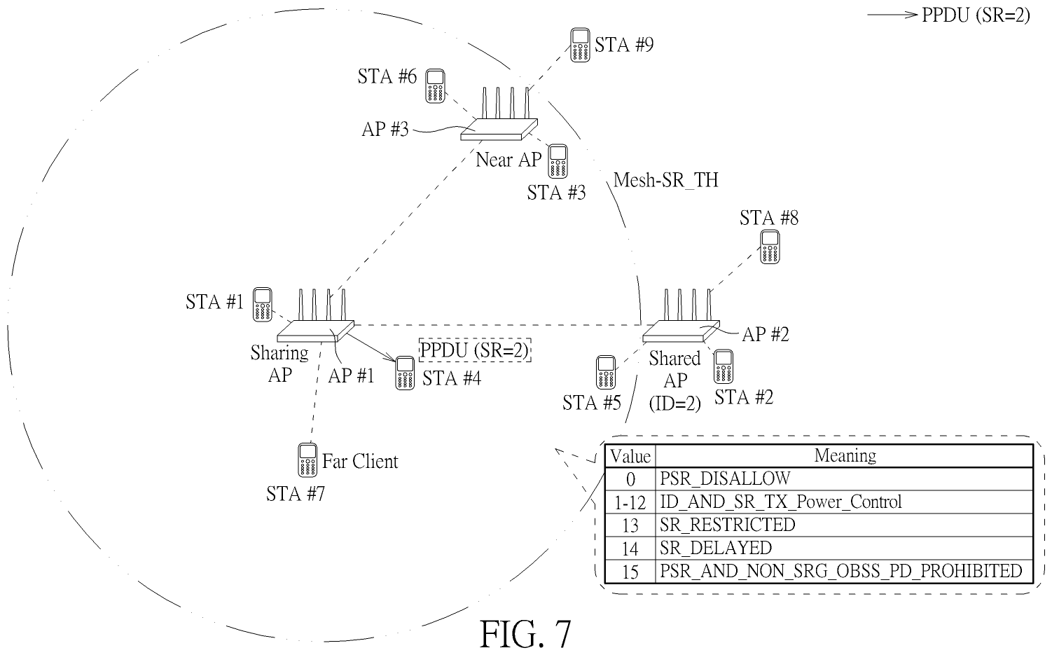

FIG. 7 is a diagram illustrating a shared-AP assigning control scheme of the method according to an embodiment of the present invention. In Stage #2, the sharing AP such as the AP #1 may mark a downlink PPDU (e.g., a PPDU transmitted from the AP #1 to the STA #1 or the STA #4) with a device ID of a shared AP if the RSSI of the downlink STA reaches (or is greater than or equal to) the far-client threshold Far_Client_TH. More particularly, the AP #1 may mark the downlink PPDU with the device ID by setting the SR-field value Spatial_Reuse in the SR field of the PHY preamble of the downlink PPDU to be the ID and SR transmission power control parameter ID_AND_SR_TX_Power_Control (e.g., Spatial_Reuse=2).

As shown in FIG. 7, in comparison with the STA #7, the STAs #1 and #4 are closer to the AP #1. The RSSIs of the STAs #1 and #4 may reach the far-client threshold Far_Client_TH, and the downlink STA such as the STA #1 or the STA #4 may be regarded as a near client, and may be used as a sharing STA. For example, assuming that the ID of the AP #2 is equal to 2 (labeled “ID=2” for brevity), in response to the RSSI of the STA #4 being greater than the far-client threshold Far_Client_TH, the sharing AP such as the AP #1 may select and assign a shared AP (e.g., the AP #2) whose RSSI is lower than a mesh-SR threshold Mesh-SR_TH to be the target shared AP, and set the SR-field value Spatial_Reuse in the PHY preamble of the downlink PPDU transmitted from the AP #1 to the STA #4 to be the ID and SR transmission power control parameter ID_AND_SR_TX_Power_Control to indicate the ID of the shared AP, for example, by setting Spatial_Reuse=2 in the downlink PPDU (labeled “PPDU (SR=2)” for brevity).

For better comprehension, the STAs #1 and #4 may be illustrated to have their centers positioned within the circle corresponding to the far-client threshold Far_Client_TH as shown in FIG. 6 to indicate that the RSSIs of the STAs #1 and #4 may reach (or be greater than or equal to) the far-client threshold Far_Client_TH at this moment, and the STA #7 may be illustrated to have its center positioned outside the circle corresponding to the far-client threshold Far_Client_TH as shown in FIG. 6 to indicate that the RSSI of the STA #7 may be less than the far-client threshold Far_Client_TH at this moment. In addition, the AP #2 may be illustrated to have its center positioned outside the circle corresponding to the mesh-SR threshold Mesh-SR_TH to indicate that the RSSI of the AP #2 may be less than the mesh-SR threshold Mesh-SR_TH at this moment, and the AP #3 may be illustrated to have its center positioned within the circle corresponding to the mesh-SR threshold Mesh-SR_TH to indicate that the RSSI of the AP #3 may reach the mesh-SR threshold Mesh-SR_TH at this moment. As the RSSI of the AP #3 may reach the mesh-SR threshold Mesh-SR_TH, the AP #3 may be regarded as a near AP for the sharing AP such as the AP #1. In this situation, the AP #1 may prevent selecting and assigning the AP #3 to be the target shared AP.

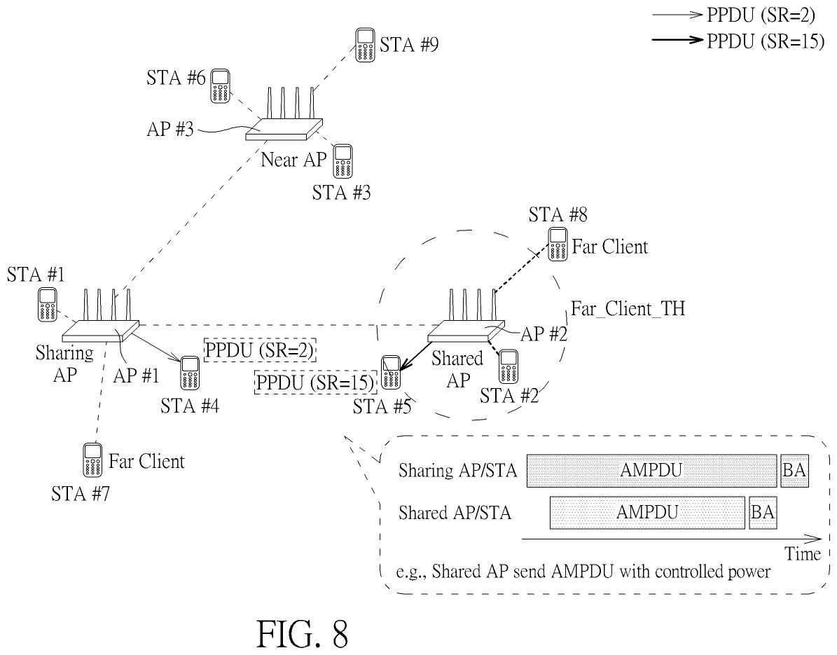

FIG. 8 is a diagram illustrating an SR-STA selecting control scheme of the method according to an embodiment of the present invention. The RSSIs of the STAs #1 and #4 may reach the far-client threshold Far_Client_TH, and the downlink STA such as the STA #1 or the STA #4 may be regarded as a near client, and may be used as a sharing STA. For example, in response to the RSSI of the STA #4 being greater than the far-client threshold Far_Client_TH, the sharing AP such as the AP #1 may select and assign the shared AP (e.g., the AP #2) whose RSSI is lower than the mesh-SR threshold Mesh-SR_TH to be the target shared AP, and set the SR-field value Spatial_Reuse in the PHY preamble of the downlink PPDU transmitted from the AP #1 to the STA #4 to be the ID and SR transmission power control parameter ID_AND_SR_TX_Power_Control to indicate the ID of the shared AP, for example, by setting Spatial_Reuse=2 in the downlink PPDU (labeled “PPDU (SR=2)” for brevity).

In Stage #3, while receiving the PPDU from the sharing AP such as the AP #1, the shared AP such as the AP #2 may select a STA whose RSSI is higher than (or equal to) the far-client threshold Far_Client_TH to be a shared STA, in order to induce SR transmission concurrently. The RSSIs of the STAs #2 and #5 may reach the far-client threshold Far_Client_TH, and the downlink STA such as the STA #2 or the STA #5 may be regarded as a near client, and may be used as the shared STA. For example, in response to the RSSI of the STA #5 being greater than or equal to the far-client threshold Far_Client_TH, the shared AP such as the AP #2 may perform SR transmission with respect to the PPDU transmitted from the AP #1 to the STA #4, and more particularly, transmit another PPDU such as the second PPDU to the shared STA such as the STA #5, and mark the second PPDU as SR prohibited by setting Spatial_Reuse=15 in the second PPDU (labeled “PPDU (SR=15)” for brevity), for indicating that no further SR transmission with respect to any existing PPDU (e.g., the first PPDU and/or the second PPDU) is allowed.

As shown in the timing chart at the lower right corner of FIG. 8, the sharing AP such as the AP #1 may send the first PPDU carrying a set of first aggregate medium access control (MAC) protocol data units (A-MPDUs) to the sharing STA such as the STA #4 (labeled “AMPDU” in the upper half of the timing chart for brevity), and the sharing STA such as the STA #4 may send a corresponding block acknowledgment (BA) in response to the first PPDU. In addition, the shared AP such as the AP #2 may send the second PPDU carrying a set of second A-MPDUs to the shared STA such as the STA #5 (labeled “AMPDU” in the lower half of the same timing chart for brevity), and the shared STA such as the STA #5 may send a corresponding BA in response to the second PPDU. For example, the shared AP such as the AP #2 may send the second PPDU carrying the set of second A-MPDUs with controlled power. More particularly, the transmission power of the sharing AP and STA may correspond to a higher power value (which may be illustrated with heavy shadings in the upper half of the timing chart), and the SR transmission power of the shared AP and STA may correspond to a lower power value (which may be illustrated with light shadings in the lower half of the timing chart), but the present invention is not limited thereto.

For better comprehension, the STAs #2 and #5 may be illustrated to have their centers positioned within the circle corresponding to the far-client threshold Far_Client_TH as shown in FIG. 8 to indicate that the RSSIs of the STAs #2 and #5 may reach (or be greater than or equal to) the far-client threshold Far_Client_TH at this moment, and the STA #8 may be illustrated to have its center positioned outside the circle corresponding to the far-client threshold Far_Client_TH as shown in FIG. 8 to indicate that the RSSI of the STA #8 may be less than the far-client threshold Far_Client_TH at this moment. As the RSSI of the STA #8 may be lower than the far-client threshold Far_Client_TH, the STA #8 may be regarded as a far client for the shared AP such as the AP #2. In this situation, the AP #2 will not select the STA #8 as the shared STA.

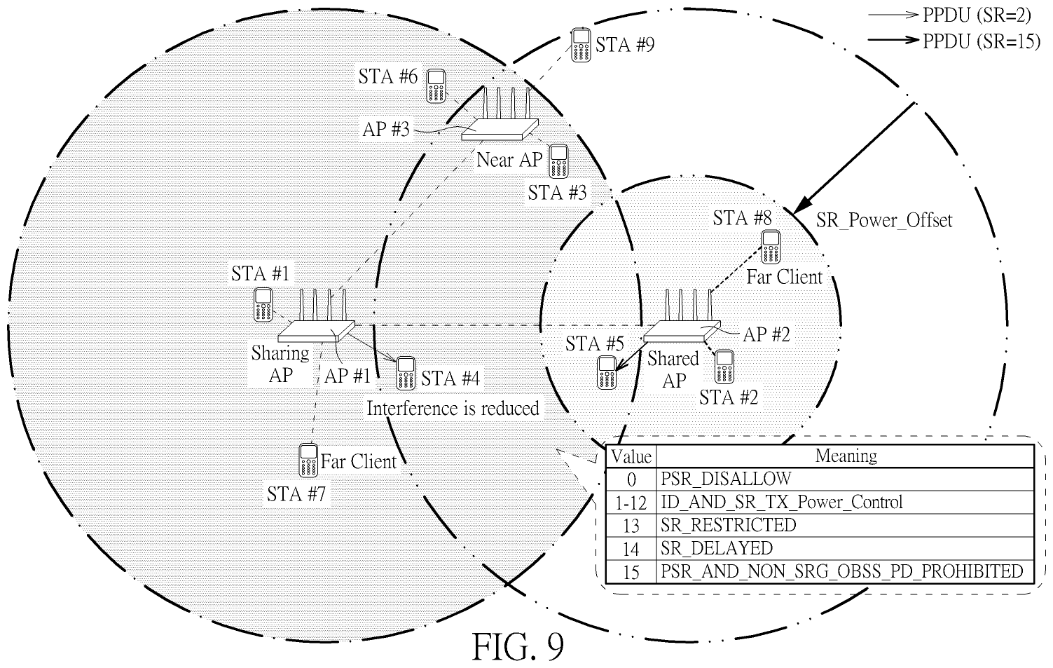

FIG. 9 is a diagram illustrating an SR power control scheme of the method according to an embodiment of the present invention. In Stage #4, the sharing AP such as the AP #1 may keep tracking the PER(s) while sharing the airtime, and notify the shared AP such as the AP #2 to control the SR transmission power if there is a need. The AP #1 may mark any downlink PPDU (e.g., the first PPDU or another first PPDU) corresponding to Stage #4 among the multiple first PPDUs with both of the device ID and the SR transmission power control indicator, and more particularly, set the SR-field value Spatial_Reuse in the SR field of the PHY preamble of the downlink PPDU to be the ID and SR transmission power control parameter ID_AND_SR_TX_Power_Control (e.g., Spatial_Reuse=2 or 8), for indicating both of the device ID and the SR transmission power control indicator.

For better comprehension, a first circle may be illustrated for the sharing AP such as the AP #1 as shown in the left half of FIG. 9 to represent the transmission range thereof, such as the range in which the downlink PPDU can reach the sharing STA such as the STA #4 with sufficient strength for the sharing STA to correctly decode the encoded information of the downlink PPDU. In addition, a second circle which is similar to or the same as the first circle and covers approximately one third of the first circle may be illustrated for the shared AP such as the AP #2 as shown in the right half of FIG. 9 to represent the original transmission range thereof, such as the transmission range corresponding to non-controlled SR transmission power, for indicating that interference would be introduced if the SR transmission power of the AP #2 were not properly controlled at this moment. Additionally, a third circle which is smaller than the second circle may be illustrated for the AP #2 as shown in the right half of FIG. 9 to represent the adjusted transmission range thereof, such as the transmission range corresponding to a power reduction of at least an SR power offset SR_Power_Offset, for indicating that interference can be reduced by applying the SR power offset SR_Power_Offset to the SR transmission power control (labeled “Interference is reduced” for brevity).

TABLE 3

| | Device | | SR TX power | |
|---|---|---|---|---|
| Value | ID | Shared AP | control indicator | SR TX power |
| 1 | 1 | AP #1 | 0 | Normal power |
| 2 | 2 | AP #2 | 0 | Normal power |
| 3 | 3 | AP #3 | 0 | Normal power |
| 4 | 4 | AP #4 | 0 | Normal power |
| 5 | 5 | AP #5 | 0 | Normal power |
| 6 | 6 | AP #6 | 0 | Normal power |
| 7 | 1 | AP #1 | 1 | Controlled power |
| 8 | 2 | AP #2 | 1 | Controlled power |
| 9 | 3 | AP #3 | 1 | Controlled power |
| 10 | 4 | AP #4 | 1 | Controlled power |
| 11 | 5 | AP #5 | 1 | Controlled power |
| 12 | 6 | AP #6 | 1 | Controlled power |

TABLE 4

| | Device | | SR TX power | SR TX power |
|---|---|---|---|---|
| Value | ID | Shared AP | control indicator | control |
| 1 | 1 | AP #1 | 0 | Keep SR power |
| 2 | 2 | AP #2 | 0 | Keep SR power |
| 3 | 3 | AP #3 | 0 | Keep SR power |
| 4 | 4 | AP #4 | 0 | Keep SR power |
| 5 | 5 | AP #5 | 0 | Keep SR power |
| 6 | 6 | AP #6 | 0 | Keep SR power |
| 7 | 1 | AP #1 | 1 | Reduce SR power |
| 8 | 2 | AP #2 | 1 | Reduce SR power |
| 9 | 3 | AP #3 | 1 | Reduce SR power |
| 10 | 4 | AP #4 | 1 | Reduce SR power |
| 11 | 5 | AP #5 | 1 | Reduce SR power |
| 12 | 6 | AP #6 | 1 | Reduce SR power |

TABLE 5

| | Device | | SR TX power | SR TX power |
|---|---|---|---|---|
| Value | ID | Shared AP | control indicator | control |
| 1 | 1 | AP #1 | 0 | Increase SR power |
| 2 | 2 | AP #2 | 0 | Increase SR power |
| 3 | 3 | AP #3 | 0 | Increase SR power |
| 4 | 4 | AP #4 | 0 | Increase SR power |
| 5 | 5 | AP #5 | 0 | Increase SR power |
| 6 | 6 | AP #6 | 0 | Increase SR power |
| 7 | 1 | AP #1 | 1 | Reduce SR power |
| 8 | 2 | AP #2 | 1 | Reduce SR power |
| 9 | 3 | AP #3 | 1 | Reduce SR power |
| 10 | 4 | AP #4 | 1 | Reduce SR power |
| 11 | 5 | AP #5 | 1 | Reduce SR power |
| 12 | 6 | AP #6 | 1 | Reduce SR power |

Table 3 illustrates an example of the ID and SR transmission power control parameter ID_AND_SR_TX_Power_Control generated by encoding the device ID and the SR transmission (TX) power control indicator, Table 4 illustrates another example of the ID and SR transmission power control parameter ID_AND_SR_TX_Power_Control generated by encoding the device ID and the SR TX power control indicator, and Table 5 illustrates yet another example of the ID and SR transmission power control parameter ID_AND_SR_TX_Power_Control generated by encoding the device ID and the SR TX power control indicator, where the shared AP indicated by the device ID and the associated SR TX power and/or SR TX power control indicated by the SR TX power control indicator are also illustrated for better comprehension, and M=6, but the present invention is not limited thereto. In some examples, the respective values of the ID and SR transmission power control parameter ID_AND_SR_TX_Power_Control, the device ID and the SR TX power control indicator, the way of encoding the device ID and the SR TX power control indicator to generate the ID and SR transmission power control parameter ID_AND_SR_TX_Power_Control, the associated SR TX power/SR TX power control, and/or the AP device count M may vary.

Both of the device assignment indication such as the device ID and the transmission power control indication such as the SR TX power control indicator may be integrated into an encoded indication such as the ID and SR transmission power control parameter ID_AND_SR_TX_Power_Control, where the encoded indication may be carried by a predetermined field in the PHY preamble. For example, the predetermined field may be the SR field in the PHY preamble, and the encoded indication may be the SR-field value Spatial_Reuse for indicating the device assignment indication and the transmission power control indication, such as the device ID and the SR TX power control indicator shown in Tables 3-5. In this situation, the SR-field value Spatial_Reuse may be equal to any value among multiple integer values {1, 2, . . . , 12} in the predetermined interval [1, 12]. For another example, the predetermined field may be the other field (i.e., the aforementioned another field in the PHY preamble), and the encoded indication may be the field value of the other field for indicating the device assignment indication and the transmission power control indication, such as the device ID and the SR TX power control indicator shown in Tables 3-5. In this situation, the field value of the other field may be equal to any value among another set of predetermined candidate values in the other field. In addition, the first network device such as the AP #1 may generate the encoded indication such as the ID and SR transmission power control parameter ID_AND_SR_TX_Power_Control according to one or more predetermined mapping relationships, for mapping the device assignment indication and the transmission power control indication (e.g., the device ID and the SR TX power control indicator shown in Tables 3-5) to the encoded indication, to allow the third network device such as the AP #2 to obtain the device assignment indication and the transmission power control indication from the encoded indication according to the one or more predetermined mapping relationships.

Assuming that the symbols “Device_ID” and “SR_TX_Power_Control” may represent the device ID and the SR TX power control indicator, the first network device such as the AP #1 may perform encoding on the device ID Device_ID and the SR TX power control indicator SR_TX_Power_Control to generate the ID and SR transmission power control parameter ID_AND_SR_TX_Power_Control as shown in Tables 3-5 according to the following equation:

ID_AND_SR_TX_Power_Control=Device_ID+SR_TX_Power_Control*SHIFTER;
where “SHIFTER” may represent a shifter such as shifting amount for selectively shifting a set of ID values {1, 2, 3, 4, 5, 6} to a set of shifted ID values{7, 8, 9, 10, 11, 12} corresponding to the set of ID values {1, 2, 3, 4, 5, 6}, respectively, and SHIFTER=6 for the encoding performed in any of the examples shown in Tables 3-5, but the present invention is not limited thereto. In some examples, the above equation and the associated parameters such as the shifter SHIFTER may vary.

As shown in Table 3, the first network device such as the AP #1 may configure the ID and SR transmission power control parameter ID_AND_SR_TX_Power_Control as the set of ID values {1, 2, 3, 4, 5, 6} to assign the APs {#1, #2, #3, #4, #5, #6} to perform SR transmission with normal power, respectively, and may configure the ID and SR transmission power control parameter ID_AND_SR_TX_Power_Control as the set of shifted ID values{7, 8, 9, 10, 11, 12} to assign the APs {#1, #2, #3, #4, #5, #6} to perform SR transmission with controlled power, respectively. For example, the sharing AP such as the AP #1 may configure the ID and SR transmission power control parameter ID_AND_SR_TX_Power_Control as the ID value 2 to assign the shared AP such as the AP #2 to perform SR transmission with normal power, and monitor or detect whether the PER is high while the AP #2 is performing SR transmission. When the AP #1 detects that the PER is high while the AP #2 is performing SR transmission, the AP #1 may control the AP #2 through the ID and SR transmission power control parameter ID_AND_SR_TX_Power_Control to reduce the SR power, and more particularly, configure the ID and SR transmission power control parameter ID_AND_SR_TX_Power_Control as the shifted ID value 8 to assign the AP #2 to perform SR transmission with controlled power for the next time. Regarding the controlled power shown in Table 3, the shared AP such as the AP #2 may adjust the SR TX Power to be 10 dB lower than the normal power, where the SR power offset SR_Power_Offset may be equal to 10 (dB), but the present invention is not limited thereto. In some examples, the controlled power and/or the SR power offset SR_Power_Offset may vary.

As shown in Table 4, the first network device such as the AP #1 may configure the ID and SR transmission power control parameter ID_AND_SR_TX_Power_Control as the set of ID values {1, 2, 3, 4, 5, 6} to assign the APs {#1, #2, #3, #4, #5, #6} to perform SR transmission and keep the SR power (or SR TX power) without changing it, respectively, and may configure the ID and SR transmission power control parameter ID_AND_SR_TX_Power_Control as the set of shifted ID values{7, 8, 9, 10, 11, 12} to assign the APs {#1, #2, #3, #4, #5, #6} to perform SR transmission and reduce the SR power (or SR TX power), respectively. For example, the sharing AP such as the AP #1 may configure the ID and SR transmission power control parameter ID_AND_SR_TX_Power_Control as the ID value 2 to assign the shared AP such as the AP #2 to perform SR transmission and keep the SR power, and monitor or detect whether the PER is high while the AP #2 is performing SR transmission. When the AP #1 detects that the PER is high while the AP #2 is performing SR transmission, the AP #1 may control the AP #2 through the ID and SR transmission power control parameter ID_AND_SR_TX_Power_Control to adjust the SR power.

In response to the ID and SR transmission power control parameter ID_AND_SR_TX_Power_Control indicating reducing the SR power (labeled “Reduce SR power” in Table 4), the shared AP such as the AP #2 may reduce the current SR power by 3 dB, where the shared AP may increase the SR power offset SR_Power_Offset with an increment of 3 (dB), but the present invention is not limited thereto. In response to the ID and SR transmission power control parameter ID_AND_SR_TX_Power_Control indicating keeping the SR power (labeled “Keep SR power” in Table 4), which means that the current SR power is appropriate, the shared AP such as the AP #2 may keep the current SR power. In addition, the shared AP may intent to increase the SR power by 3 dB after receiving successive “Keep SR power” indicator (e.g., SR_TX_Power_Control=0) carried by the ID and SR transmission power control parameter ID_AND_SR_TX_Power_Control. For example, after receiving 5 successive “Keep SR power” indicators, the shared AP may decrease SR power offset SR_Power_Offset with a decrement of 3 (dB). In some examples, the increment and the decrement for adjusting the SR power offset SR_Power_Offset may vary.

As shown in Table 5, the first network device such as the AP #1 may configure the ID and SR transmission power control parameter ID_AND_SR_TX_Power_Control as the set of ID values {1, 2, 3, 4, 5, 6} to assign the APs {#1, #2, #3, #4, #5, #6} to perform SR transmission and increase the SR power (or SR TX power) to correspond to a higher power value, respectively, and may configure the ID and SR transmission power control parameter ID_AND_SR_TX_Power_Control as the set of shifted ID values{7, 8, 9, 10, 11, 12} to assign the APs {#1, #2, #3, #4, #5, #6} to perform SR transmission and reduce the SR power (or SR TX power) to correspond to a lower power value, respectively. For example, the sharing AP such as the AP #1 may configure the ID and SR transmission power control parameter ID_AND_SR_TX_Power_Control as the ID value 2 to assign the shared AP such as the AP #2 to perform SR transmission, and monitor or detect whether the PER is high while the AP #2 is performing SR transmission, in order to selectively increase or reduce the SR power. When the sharing AP (e.g., the AP #1) detects that the PER is high while the shared AP (e.g., the AP #2) is performing SR transmission, the sharing AP may inform the shared AP through the ID and SR transmission power control parameter ID_AND_SR_TX_Power_Control to reduce the SR power. When the sharing AP (e.g., the AP #1) detects that the PER is low while the shared AP (e.g., the AP #2) is performing SR transmission, the sharing AP may inform the shared AP through the ID and SR transmission power control parameter ID_AND_SR_TX_Power_Control to increase the SR power.

In response to the ID and SR transmission power control parameter ID_AND_SR_TX_Power_Control indicating reducing the SR power (labeled “Reduce SR power” in Table 5), the shared AP such as the AP #2 may reduce the current SR power by 3 dB, where the shared AP may increase the SR power offset SR_Power_Offset with an increment of 3 (dB), but the present invention is not limited thereto. In response to the ID and SR transmission power control parameter ID_AND_SR_TX_Power_Control indicating increasing the SR power (labeled “Increase SR power” in Table 5), the shared AP such as the AP #2 may increase the current SR power by 3 dB. where the shared AP may decrease the SR power offset SR_Power_Offset with a decrement of 3 (dB). In some examples, the increment and the decrement for adjusting the SR power offset SR_Power_Offset may vary.

According to some embodiments, the first network device (e.g., the sharing AP such as the AP #1) may selectively communicate with the third network device (e.g., the shared AP such as the AP #2) according to a mesh protocol in advance for sending the device assignment indication to the third network device, or integrate both of the device assignment indication and the transmission power control indication into the encoded indication (e.g., the ID and SR transmission power control parameter ID_AND_SR_TX_Power_Control) carried by the predetermined field in the PHY preamble. More particularly, in a situation where both of the device assignment indication and the transmission power control indication are integrated into the encoded indication carried by the predetermined field in the PHY preamble, the predetermined field may comprise one or a combination of the SR field and the other field in the PHY preamble, and the encoded indication may be a first field value for indicating the device assignment indication and the transmission power control indication. For example:
(1) if the predetermined field comprises the SR field, the first field value may be the SR-field value Spatial_Reuse, where the SR-field value Spatial_Reuse may be equal to any value among the multiple integer values {1, 2, . . . , 12} in the predetermined interval [1, 12]; and
(2) if the predetermined field comprises the other field or the combination of the SR field and the other field, the first field value may be equal to any value among the multiple integer values {1, 2, . . . , 12} in the predetermined interval [1, 12], or equal to any value among multiple integer values in another predetermined interval;
but the present invention is not limited thereto. For brevity, similar descriptions for these embodiments are not repeated in detail here.

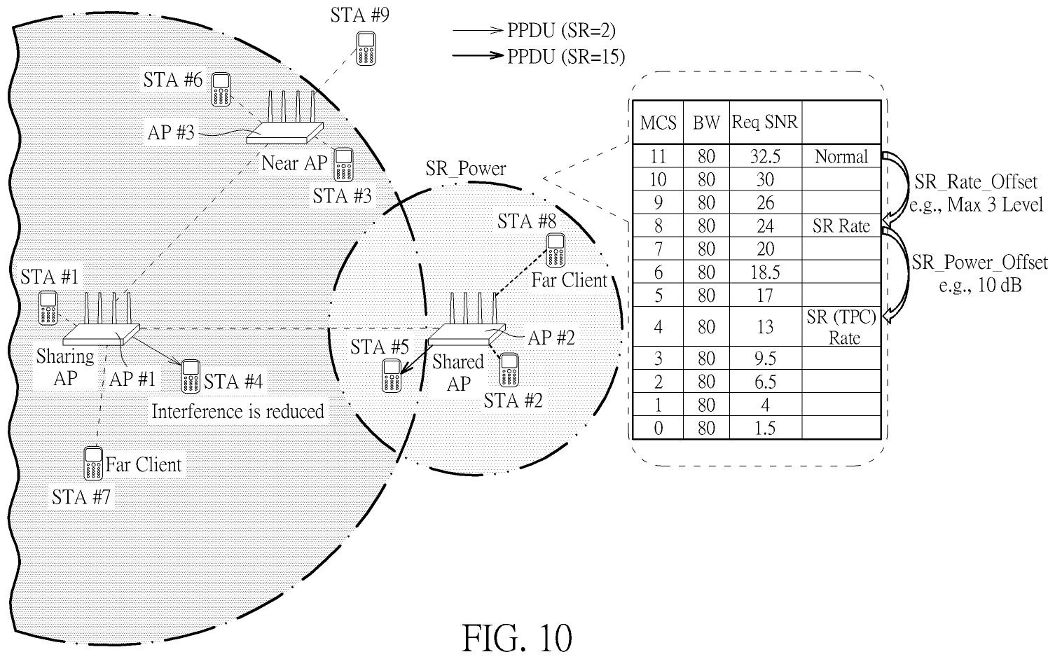

FIG. 10 is a diagram illustrating an SR rate selection control scheme of the method according to an embodiment of the present invention. For example, in response to the transmission power control indication (e.g., the SR TX power control indicator SR_TX_Power_Control) indicating that adjusting the SR transmission power is requested, the third network device such as the AP #2 may adjust the SR transmission power of the second data transmission frame (e.g., the second PPDU) transmitted from the third network device to a fourth network device (e.g., the STA #2 or the STA #5) according to at least one adjustment control parameter, where the aforementioned at least one adjustment control parameter may comprise one or a combination of an SR rate offset SR_Rate_Offset and the SR power offset SR_Power_Offset, but the present invention is not limited thereto. In some examples, the aforementioned at least one adjustment control parameter may vary.

TABLE 6

| MCS | BW | Required SNR | Remark |
|---|---|---|---|
| 11 | 80 | 32.5 | Normal |
| 10 | 80 | 30 | |
| 9 | 80 | 26 | |
| 8 | 80 | 24 | SR Rate |
| 7 | 80 | 20 | |
| 6 | 80 | 18.5 | |
| 5 | 80 | 17 | |
| 4 | 80 | 13 | SR (TPC) Rate |
| 3 | 80 | 9.5 | |
| 2 | 80 | 6.5 | |
| 1 | 80 | 4 | |
| 0 | 80 | 1.5 | |

Table 6 illustrates an example of a set of predetermined rate for being selected in the SR rate selection control scheme, where the fields “MCS” and “BW” may represent the modulation and coding scheme (MCS) and the bandwidth (BW) as defined in at least one version of the IEEE 802.11 standards, and the field “Required SNR” (labeled “Req SNR” in FIG. 10 for brevity) may represent the required SNR of the combination {MCS, BW} thereof, but the present invention is not limited thereto. In some examples, the modulation and coding scheme, the bandwidth and/or the required SNR may vary. In addition, the associated modulation parameters involved with the method may comprise the MCS and the BW, but the present invention is not limited thereto. In some examples, the associated modulation parameters may comprise various parameters such as the transmission mode (TX Mode), the BW, the NSS, the MCS, etc.

In Stage #5, the third network device such as the AP #2 may perform SR rate selection according to the SR rate offset SR_Rate_Offset and the SR power offset SR_Power_Offset, and more particularly, perform a first SR-rate switching such as a first SR-rate reduction operation according to the SR rate offset SR_Rate_Offset to switch from a normal rate (labeled “Normal” for brevity) to a first SR rate such as the SR rate shown in Table 6, and perform a second SR-rate switching such as a second SR-rate reduction operation according to the SR power offset SR_Power_Offset to switch from the first SR rate to a second SR rate such as the SR transmission power control (TPC) rate shown in Table 6. The SR TPC rate may be regarded as an SR power controlled rate. In addition, the shared AP such as the AP #2 may be equipped multiple automatic MCS adjustment mechanisms such as a normal rate adaptation mechanism and an SR rate adaptation mechanism within the shared AP. Based on the normal rate adaptation mechanism, the shared AP may determine the normal rate of the normal transmission according to the receiving side quality (e.g., the PER) at the shared STA (e.g., the STA #5), in order to enhance the normal transmission performance. Based on the SR rate adaptation mechanism, the shared AP may determine the SR rate of the SR transmission according to the receiving side quality (e.g., the PER) at the shared STA (e.g., the STA #5), in order to enhance the SR transmission performance. For example, when it is needed to perform the SR transmission, the shared AP such as the AP #2 may determine the SR rate offset SR_Rate_Offset according to the SR rate adaptation mechanism to determine the SR rate. Additionally, the shared AP such as the AP #2 may determine the SR power offset SR_Power_Offset according to the transmission power control indication (e.g., the SR TX power control indicator SR_TX_Power_Control) of the sharing AP (e.g., the AP #1).

For example, the normal rate, the first SR rate and the second SR rate may represent the rates of MCS=11, MCS=8 and MCS=4, respectively, and the SR-rate switching of the SR rate offset SR_Rate_Offset and the SR power offset SR_Power_Offset may correspond to the switching of one or more levels/rows up to maximum 3 levels/rows in Table 6 and the switching of levels/rows for 10 decibel (dB) reduction of the required SNR in Table 6, respectively, where SR_Rate_Offset=3 and SR_Power_Offset=10 (dB), but the present invention is not limited thereto. In some examples, the normal rate, the first SR rate, the second SR rate, the SR rate offset SR_Rate_Offset and the SR power offset SR_Power_Offset may vary.

According to the SR rate selection control scheme, the third network device such as the AP #2 may determine the first SR rate (e.g., the rate without power control) to be the normal rate minus the SR rate offset SR_Rate_Offset, and determine the second SR rate (e.g., the rate with power control) by looking up a target rate whose required SNR is equal to the required SNR of the first SR rate minus the SR power offset SR_Power_Offset. For example, the small circle corresponding to the SR power SR_Power as illustrated in FIG. 10 may indicate the SR TX power adjustment result, but the present invention is not limited thereto. In some examples, the SR TX power adjustment result may vary.

As shown in FIGS. 5-10, the multiple network devices may operate in Stages #0, #1, #2, #3, #4 and #5 as described above, respectively, but the present invention is not limited thereto. According to some embodiments, as long as implementation of the present invention will not be hindered, the multiple network devices may perform one or a combination of the respective operations of Stages #0, #1, #2, #3, #4 and #5 arbitrarily.

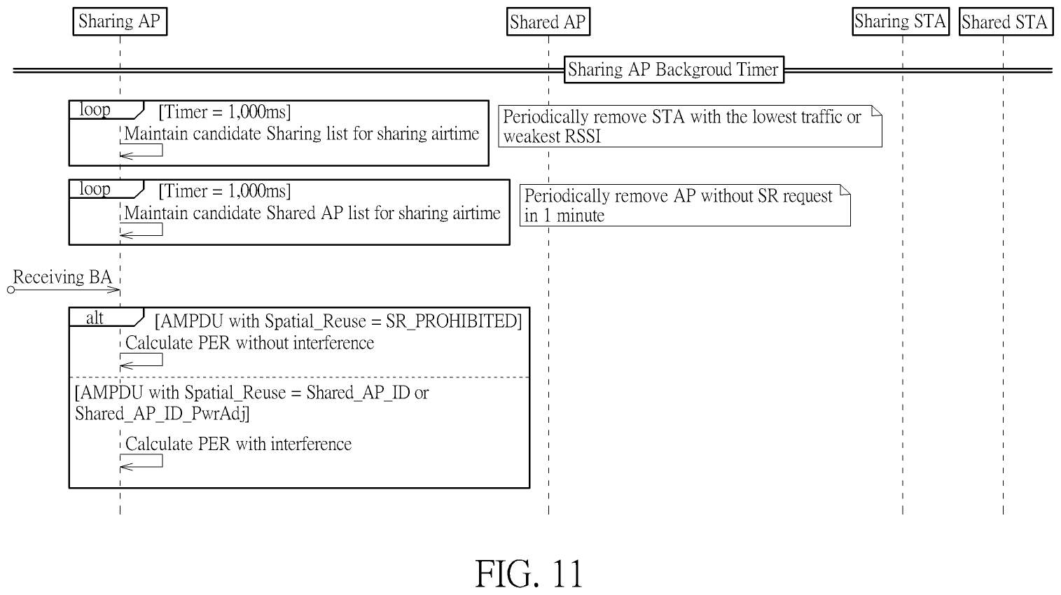

FIG. 11 is a diagram illustrating a sharing-AP timing and PER calculation control scheme of the method according to an embodiment of the present invention. The sharing AP such as the AP #1 may execute at least one loop-based procedure for performing operations in at least one loop and at least one alternative/selective control procedure for performing alternative or selective operations (respectively labeled “loop” and “alt” for brevity) according to at least one sharing AP background timer therein. For example, the sharing AP may configure a first sharing AP background timer in a first loop-based procedure having a first loop with a first predetermined period such as 1000 milliseconds (ms) (labeled “Timer=1,000 ms” for brevity) to maintain a candidate sharing list (e.g. a candidate sharing STA list arranged to record one or more candidate sharing STAs) for sharing airtime, and periodically remove any STA with the lowest traffic or weakest RSSI from the candidate sharing list. In addition, the sharing AP may configure a second sharing AP background timer in a second loop-based procedure having a second loop with a second predetermined period such as 1000 ms (labeled “Timer=1,000 ms” for brevity) to maintain a candidate shared AP list (e.g., the candidate shared AP list arranged to record one or more candidate shared APs) for sharing airtime, and periodically remove any AP without any SR request in one minute, such as an AP that had not sent any SR request in one minute to the sharing AP. When receiving a BA from any sharing STA, the sharing AP may execute a first alternative/selective control procedure to select a first predetermined operation from multiple first predetermined operations according to the ID and SR transmission power control parameter ID_AND_SR_TX_Power_Control, and perform the first predetermined operation, where the BA is sent by this sharing STA in response to a downlink PPDU (e.g., a PPDU previously transmitted from the sharing AP to the sharing STA). More particularly, the device ID Device_ID of the shared AP and the combination of the device ID Device_ID and the SR TX power control indicator SR_TX_Power_Control may be implemented as a shared AP ID Shared_AP_ID of the shared AP and a shifted shared AP ID Shared_AP_ID_PwrAdj of the shared AP for indicating power adjustment/control, respectively, such as the set of ID values {1, 2, 3, 4, 5, 6} and the set of shifted ID values{7, 8, 9, 10, 11, 12}, respectively, but the present invention is not limited thereto. For example, if the downlink PPDU carrying A-MPDUs had been configured with the ID and SR transmission power control parameter ID_AND_SR_TX_Power_Control such as the SR-field value Spatial_Reuse in the PHY preamble being set as the parameter PSR_AND_NON_SRG_OBSS_PD_PROHIBITED (labeled “AMPDU with Spatial_Reuse=SR_PROHIBITED” for brevity), the sharing AP may calculate the PER without interference; otherwise, if the downlink PPDU carrying A-MPDUs had been configured with the ID and SR transmission power control parameter ID_AND_SR_TX_Power_Control such as the SR-field value Spatial_Reuse in the PHY preamble being set as the device ID Device_ID of the shared AP or a combination of the device ID Device_ID of the shared AP and the SR TX power control indicator SR_TX_Power_Control (labeled “AMPDU with Spatial_Reuse=Shared_AP_ID or Shared_AP_ID_PwrAdj” for brevity, where “PwrAdj” may stand for power adjustment/control), the sharing AP may calculate the PER with interference.

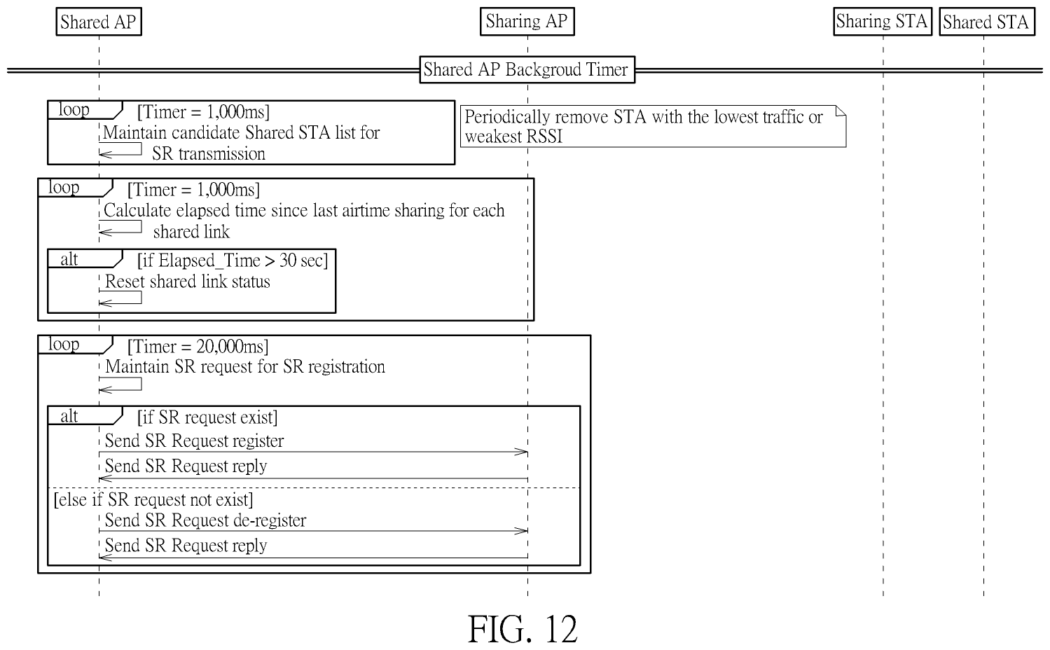

FIG. 12 is a diagram illustrating a shared-AP timing and SR-request maintaining control scheme of the method according to an embodiment of the present invention. For example, the shared AP such as the AP #2 may execute at least one loop-based procedure for performing operations in at least one loop and at least one alternative/selective control procedure for performing alternative or selective operations (respectively labeled “loop” and “alt” for brevity) according to at least one shared AP background timer therein. The shared AP may configure a first shared AP background timer in a third loop-based procedure having a third loop with a third predetermined period such as 1000 ms (labeled “Timer=1,000 ms” for brevity) to maintain a candidate shared STA list (e.g. the candidate shared STA list arranged to record one or more candidate shared STAs) for SR transmission, and periodically remove any STA with the lowest traffic or weakest RSSI from the candidate shared STA list. In addition, the shared AP may configure a second shared AP background timer in a fourth loop-based procedure having a fourth loop with a fourth predetermined period such as 1000 ms (labeled “Timer=1,000 ms” for brevity) to calculate an elapsed time Elapsed_Time since the last airtime sharing for each shared link, and may execute a second alternative/selective control procedure to determine whether to perform a second predetermined operation according to whether the elapsed time Elapsed_Time reaches a predetermined elapsed time threshold TH_Elapsed_Time such as 30 seconds (sec). For example, the shared AP may reset the shared link status if Elapsed_Time>30 sec. Additionally, the shared AP may configure a third shared AP background timer in a fifth loop-based procedure having a fifth loop with a fifth predetermined period such as 20000 ms (labeled “Timer=20,000 ms” for brevity) to maintain any SR request for SR registration, and may execute a third alternative/selective control procedure to select a third predetermined operation from multiple third predetermined operations according to whether the aforementioned any SR request exists, and perform the third predetermined operation. For example, if the aforementioned any SR request exists, the shared AP may send an SR Request register, where the sharing AP may send an SR Request reply in response to the SR Request register; otherwise, in a situation where the aforementioned any SR request does not exist (labeled “else if SR request not exist” for brevity), the shared AP may send an SR Request de-register, where the sharing AP may send an SR Request reply in response to the SR Request de-register.

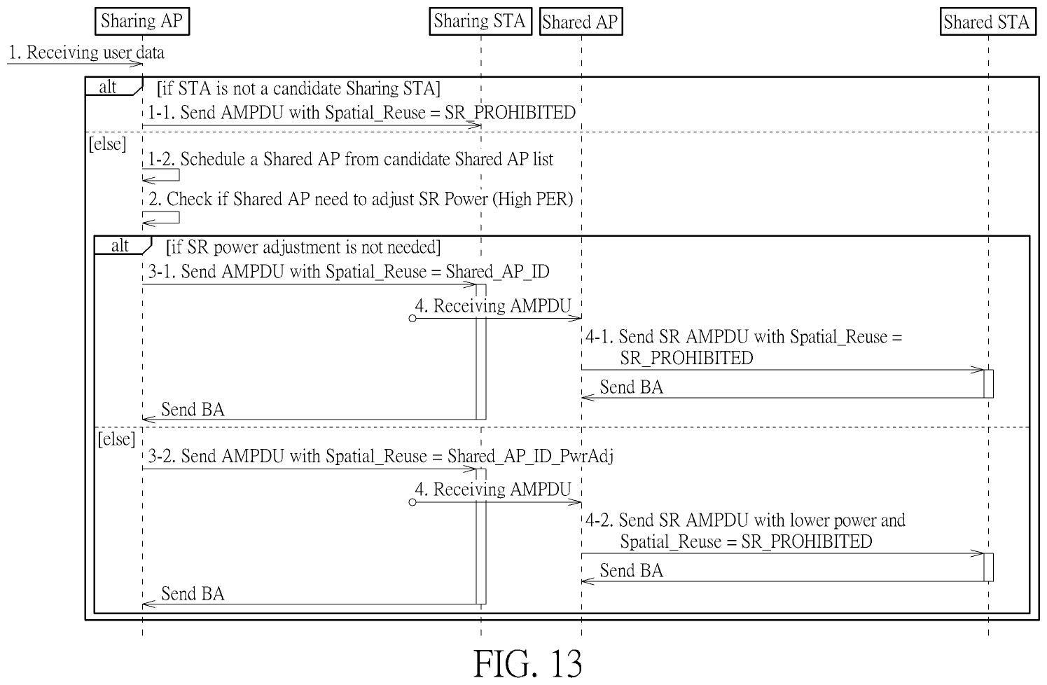

FIG. 13 is a diagram illustrating a selective airtime-sharing and SR power control scheme of the method according to an embodiment of the present invention. The sharing AP such as the AP #1 may execute at least one alternative/selective control procedure for performing alternative or selective operations, and the shared AP such as the AP #2 may perform some operations correspondingly, where the sharing and shared STAs may send BA in response to downlink frames, respectively. For example, when receiving user data, the sharing AP may execute a fourth alternative/selective control procedure (as illustrated with the outer block labeled “alt” in FIG. 13) to select a fourth predetermined operation from multiple fourth predetermined operations according to whether the STA sending the user data is not a candidate sharing STA, and perform the fourth predetermined operation. For example, if the STA is not a candidate sharing STA, the sharing AP may send a PPDU carrying A-MPDUs with the ID and SR transmission power control parameter ID_AND_SR_TX_Power_Control such as the SR-field value Spatial_Reuse in the PHY preamble being set as the parameter PSR_AND_NON_SRG_OBSS_PD_PROHIBITED to the STA (labeled “Send AMPDU with Spatial_Reuse=SR_PROHIBITED” for brevity); otherwise, as shown in the second part (staring from the line labeled “else”) of the outer block in FIG. 13, the sharing AP may schedule a shared AP from the candidate shared AP list, and check if the shared AP needs to adjust SR power (or SR TX power), for example, for the case of high PER, and further execute a fifth alternative/selective control procedure (as illustrated with the inner block labeled “alt” in FIG. 13) to select a fifth predetermined operation from multiple fifth predetermined operations according to whether the aforementioned any SR request exists, and perform the fifth predetermined operation. For example, if the SR power adjustment is not needed, the sharing AP may send a PPDU carrying A-MPDUs with the ID and SR transmission power control parameter ID_AND_SR_TX_Power_Control such as the SR-field value Spatial_Reuse in the PHY preamble being set as the device ID Device_ID (e.g., the shared AP ID Shared_AP_ID) of the shared AP to the sharing STA (labeled “Send AMPDU with Spatial_Reuse=Shared_AP_ID” for brevity), and the sharing STA may send a BA in response to the PPDU, wherein when receiving this PPDU carrying the A-MPDUs, the shared AP may send an SR PPDU carrying A-MPDUs with the ID and SR transmission power control parameter ID_AND_SR_TX_Power_Control such as the SR-field value Spatial_Reuse in the PHY preamble being set as the parameter PSR_AND_NON_SRG_OBSS_PD_PROHIBITED to the shared STA (labeled “Send SR AMPDU with Spatial_Reuse=SR_PROHIBITED” for brevity), and the shared STA may send a BA in response to the SR PPDU; otherwise, as shown in the second part (staring from the line labeled “else”) of the inner block in FIG. 13, the sharing AP may send a PPDU carrying A-MPDUs with the ID and SR transmission power control parameter ID_AND_SR_TX_Power_Control such as the SR-field value Spatial_Reuse in the PHY preamble being set as a combination (e.g., the shifted shared AP ID Shared_AP_ID_PwrAdj) of the device ID Device_ID of the shared AP and the SR TX power control indicator SR_TX_Power_Control to the sharing STA (labeled “Send AMPDU with Spatial_Reuse=Shared_AP_ID_PwrAdj” for brevity, where “PwrAdj” may stand for power adjustment/control), and the sharing STA may send a BA in response to the PPDU, wherein when receiving this PPDU carrying the A-MPDUs, the shared AP may send an SR PPDU carrying A-MPDUs with lower power and with the ID and SR transmission power control parameter ID_AND_SR_TX_Power_Control such as the SR-field value Spatial_Reuse in the PHY preamble being set as the parameter PSR_AND_NON_SRG_OBSS_PD_PROHIBITED to the shared STA (labeled “Send SR AMPDU with lower power and Spatial_Reuse=SR_PROHIBITED” for brevity), and the shared STA may send a BA in response to the SR PPDU.

According to some embodiments, any PPDU among the PPDUs of the embodiments described above, such as the first PPDU, the second PPDU, any of the multiple first PPDUs, any of the multiple second PPDUs, etc., may be implemented by way of high efficiency (HE) single user (SU) PPDU, HE multi-user (MU) PPDU, extremely high throughput (EHT) SU PPDU or EHT MU PPDU. For brevity, similar descriptions for these embodiments are not repeated in detail here.

According to some embodiments, any frame among the data transmission frames of the embodiments described above, such as the first data transmission frame, the second data transmission frame, any of the multiple first data transmission frames, any of the multiple second data transmission frames, etc., may be a non-trigger-based (non-TB) frame such as a frame which is not a trigger-based (TB) frame. More particularly, the aforementioned any PPDU such as the first PPDU, the second PPDU, any of the multiple first PPDUs, any of the multiple second PPDUs, etc. may be a non-TB PPDU such as a PPDU which is not a TB PPDU. For brevity, similar descriptions for these embodiments are not repeated in detail here.

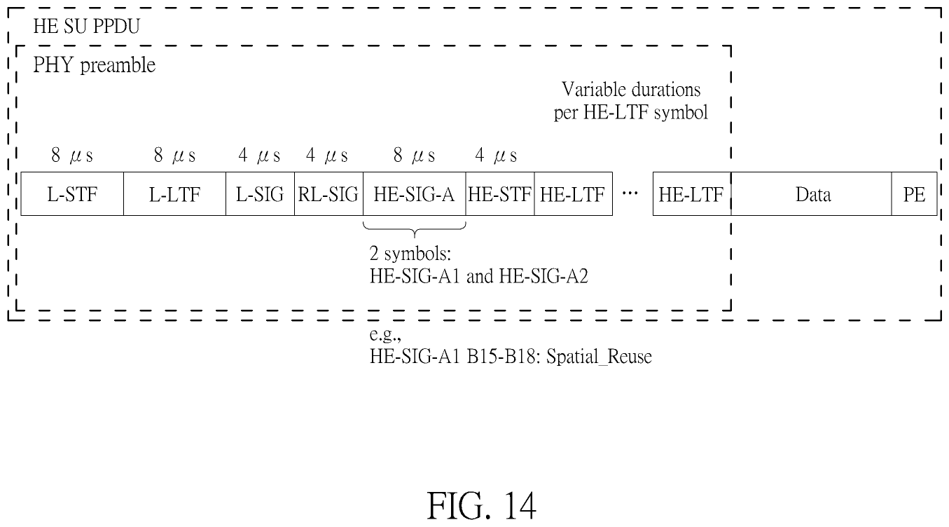

FIG. 14 is a diagram illustrating a first PPDU format involved with the method according to an embodiment of the present invention, where the first PPDU format may represent the format of the HE SU PPDU. For example, at least one portion (e.g., a portion or all) of the PPDUs in the embodiments described above, such as the first PPDU, the second PPDU, the four PPDUs, the two PPDUs, etc., may be implemented by way of the HE SU PPDU shown in FIG. 14. The PHY preamble in the HE SU PPDU may comprise multiple fields {L-STF, L-LTF, L-SIG, RL-SIG, HE-SIG-A, HE-STF, HE-LTF, . . . , HE-LTF} with predetermined durations (e.g., 8 microseconds (s) for each of the fields {L-STF, L-LTF, HE-SIG-A}, and 4 s for each of the fields {L-SIG, RL-SIG, HE-STF}) and variable durations per HE-LTF symbol, and the HE SU PPDU may further comprise a data field arranged to carry data and another field such as PE, where the field HE-SIG-A may carry two symbols such as HE-SIG-A1 and HE-SIG-A2. For example, Bits 15-18 of the symbol HE-SIG-A1 may be arranged to carry the SR-field value Spatial_Reuse (labeled “HE-SIG-A1 B15-B18: Spatial_Reuse” for brevity).

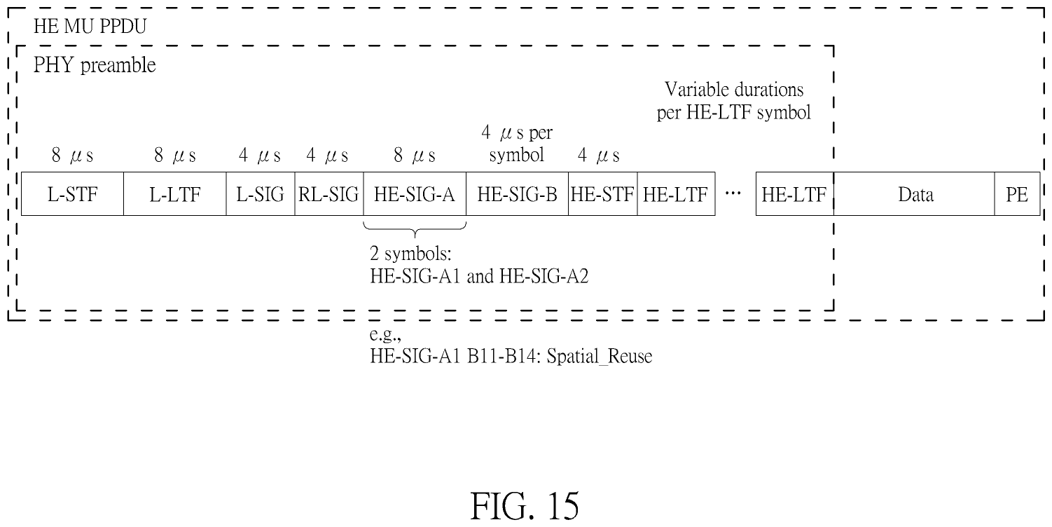

FIG. 15 is a diagram illustrating a second PPDU format involved with the method according to an embodiment of the present invention, where the second PPDU format may represent the format of the HE MU PPDU. For example, at least one portion (e.g., a portion or all) of the PPDUs in the embodiments described above, such as the first PPDU, the second PPDU, the four PPDUs, the two PPDUs, etc., may be implemented by way of the HE MU PPDU shown in FIG. 15. The PHY preamble in the HE MU PPDU may comprise multiple fields {L-STF, L-LTF, L-SIG, RL-SIG, HE-SIG-A, HE-SIG-B, HE-STF, HE-LTF, . . . , HE-LTF} with predetermined durations (e.g., 8 μs for each of the fields {L-STF, L-LTF, HE-SIG-A}, 4 μs for each of the fields {L-SIG, RL-SIG, HE-STF}, and 4 μs per symbol for the field HE-SIG-B) and variable durations per HE-LTF symbol, and the HE MU PPDU may further comprise a data field arranged to carry data and another field such as PE, where the field HE-SIG-A may carry two symbols such as HE-SIG-A1 and HE-SIG-A2. For example, Bits 11-14 of the symbol HE-SIG-A1 may be arranged to carry the SR-field value Spatial_Reuse (labeled “HE-SIG-A1 B11-B14: Spatial_Reuse” for brevity).

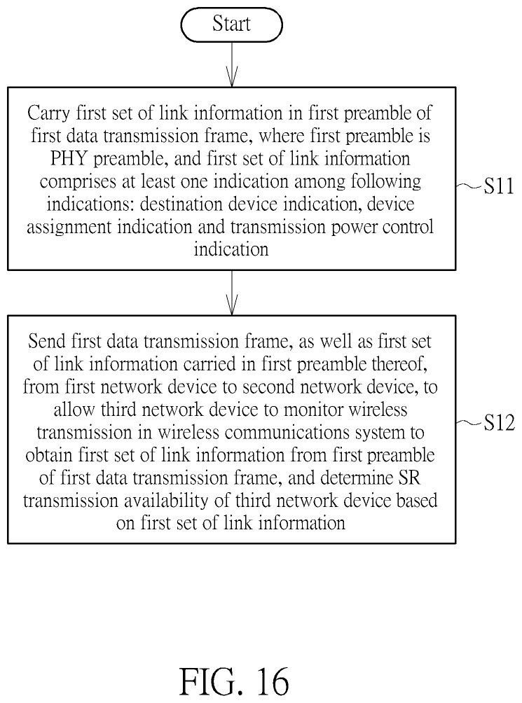

FIG. 16 illustrates a working flow of the method according to an embodiment of the present invention.

In Step S11, the first network device (e.g., the AP #1) may carry the first set of link information in the first preamble of the first data transmission frame (e.g., the first PPDU among the four PPDUs), where the first preamble is the PHY preamble of the first data transmission frame, and the first set of link information may comprise the aforementioned at least one indication among the following indications:
(1) the destination device indication such as the device ID (e.g., the sharing STA ID Sharing_STA_ID) of the sharing STA, for indicating the destination device of the data transmission frame (e.g., the first PPDU);
(2) the device assignment indication such as the device ID Device_ID of a shared AP (e.g., one of the APs #2 and #3), for indicating the target network device (e.g., the target shared AP) which is allowed to perform SR transmission; and
(3) the transmission power control indication such as the SR TX power control indicator SR_TX_Power_Control, for indicating the way of controlling the associated SR transmission power;
where the aforementioned at least one indication may be implemented as the ID and SR transmission power control parameter ID_AND_SR_TX_Power_Control.

In Step S12, the first network device may send the first data transmission frame (e.g., the first PPDU), as well as the first set of link information carried in the first preamble (e.g., the PHY preamble) thereof, from the first network device to the second network device, to allow the third network device to monitor wireless transmission in the wireless communications system 100 to obtain the first set of link information from the first preamble (e.g., the PHY preamble) of the first data transmission frame (e.g., the first PPDU), and determine the SR transmission availability of the third network device based on the first set of link information.

More particularly, the third network device (e.g., the AP #2) may obtain the first set of link information from the PHY preamble of the first data transmission frame (e.g., the first PPDU) only, having no need to decode the remaining frame contents (e.g., a MAC header) of the first data transmission frame (e.g., the first PPDU). In a situation where the signal strength of the first data transmission frame is insufficient at the third network device for correctly decoding the remaining frame contents (e.g., the MAC header) of the first data transmission frame, the operations of third network device will not be hindered. When there is a need, the third network device is capable of performing an SR transmission operation to another network device with respect to the first data transmission frame (e.g., the first PPDU) in order to enhance the overall performance.

For better comprehension, the method may be illustrated with the working flow shown in FIG. 16, but the present invention is not limited thereto. According to some embodiments, one or more steps may be added, deleted, or changed in the working flow shown in FIG. 16. For example, the first network device (e.g., the sharing AP such as the AP #1) may communicate with the third network device (e.g., the shared AP such as the AP #2) according to the mesh protocol in advance, for allowing the third network device to perform the SR transmission during a predetermined time period, where the third network device may receive the first data transmission frame (e.g., the first PPDU) during the predetermined time period. In addition, the aforementioned at least one indication may further comprise a first BSS color, and the third network device (e.g., the AP #2) may detect the first BSS color carried by the first data transmission frame (e.g., the first PPDU), for determining whether the first data transmission frame is sent from the first network device (e.g., the AP #1). When the first BSS color is equal to a predetermined BSS color of the first network device, such as a first predetermined value corresponding to a first BSS controlled by the first network device, the third network device (e.g., the AP #2) may perform the SR transmission with respect to the first data transmission frame (e.g., the first PPDU), and more particularly, perform the SR transmission power control at least according to the transmission power control indication (e.g., the SR TX power control indicator SR_TX_Power_Control). For brevity, similar descriptions for these embodiments are not repeated in detail here.

According to some embodiments, the third network device (e.g., the shared AP such as the AP #2) may perform the SR transmission at least according to the device assignment indication and perform the SR transmission power control at least according to the transmission power control indication, and the first network device (e.g., the sharing AP such as the AP #1) may monitor the PER while the third network device (e.g., the AP #2) is performing the SR transmission, for guiding the SR transmission power control with another transmission power control indication (e.g., the SR TX power control indicator SR_TX_Power_Control, having the latest value thereof) carried by another first data transmission frame (e.g., another first PPDU) transmitted from the first network device to the second network device (e.g., the sharing STA such as the STA #4) according to the PER. For example, the first network device (e.g., the AP #1) may monitor the PER according to the device ID (e.g., the sharing STA ID Sharing_STA_ID) of the second network device (e.g., the sharing STA such as the STA #4) and the device ID (e.g., the device ID Device_ID) of the third network device (e.g., the shared AP such as the AP #2), for tracking the PERs of the data transmission frames from the first network device to the second network device and determining which shared AP affects the PERs of these data transmission frames, where the destination device indication may be arranged to indicate the device ID of the second network device, and the device assignment indication may be arranged to indicate the device ID of the third network device. In addition, the third network device (e.g., the AP #2) may perform the SR transmission power control according to the device ID of the first network device (e.g., the AP #1) and the device ID (e.g., the sharing STA ID Sharing_STA_ID) of the second network device (e.g., the sharing STA such as the STA #4), for tracking the transmission power control indication (e.g., the latest values of the SR TX power control indicator SR_TX_Power_Control) carried by the data transmission frames from the first network device to the second network device. For brevity, similar descriptions for these embodiments are not repeated in detail here.

According to some embodiments, the first network device (e.g., the sharing AP such as the AP #1) may monitor the PER while the third network device (e.g., the shared AP such as the AP #2) is performing the SR transmission, for guiding the SR transmission power control of the third network device with at least the transmission power control indication (e.g., the latest value of the SR TX power control indicator SR_TX_Power_Control) according to the PER. For example, the aforementioned at least one indication may comprise the device assignment indication and the transmission power control indication, for guiding the SR transmission power control. For another example, the aforementioned at least one indication may comprise the destination device indication, the device assignment indication and the transmission power control indication, for guiding the SR transmission power control. For brevity, similar descriptions for these embodiments are not repeated in detail here.

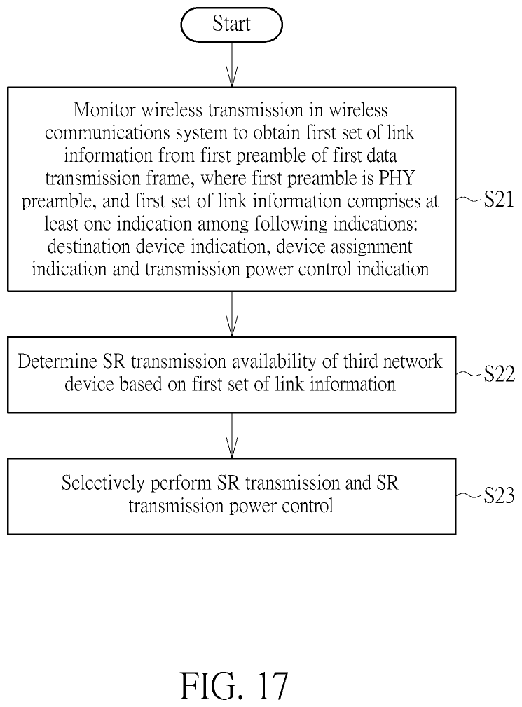

FIG. 17 illustrates a working flow of the method according to another embodiment of the present invention.

In Step S21, the third network device may monitor wireless transmission in the wireless communications system 100 to obtain the first set of link information from the first preamble of the first data transmission frame (e.g., the first PPDU), where the first preamble is the PHY preamble of the first data transmission frame, and the first set of link information may comprise the aforementioned at least one indication among the following indications:
(1) the destination device indication such as the device ID (e.g., the sharing STA ID Sharing_STA_ID) of the sharing STA, for indicating the destination device of the data transmission frame (e.g., the first PPDU);
(2) the device assignment indication such as the device ID Device_ID of the shared AP (e.g., one of the APs #2 and #3), for indicating the target network device (e.g., the target shared AP) which is allowed to perform SR transmission; and
(3) the transmission power control indication such as the SR TX power control indicator SR_TX_Power_Control, for indicating the way of controlling the associated SR transmission power;
where the aforementioned at least one indication may be implemented as the ID and SR transmission power control parameter ID_AND_SR_TX_Power_Control.

In Step S22, the third network device may determine the SR transmission availability of the third network device based on the first set of link information (e.g., the first PPDU).

In Step S23, the third network device may selectively perform the SR transmission and SR transmission power control, and more particularly, selectively perform an SR transmission operation according to the determination result of the operation of Step S22, in order to try enhancing the overall performance, and more particularly, properly control the SR transmission power according to the first set of link information when performing the SR transmission operation.

For example, the third network device may perform the SR transmission operation to another network device with respect to the first data transmission frame (e.g., the first PPDU) in order to enhance the overall performance, where the second network device can correctly receive and process the first data transmission frame (e.g., the first PPDU), without being hindered by this SR transmission operation. For brevity, similar descriptions for this embodiment are not repeated in detail here.

For better comprehension, the method may be illustrated with the working flow shown in FIG. 17, but the present invention is not limited thereto. According to some embodiments, one or more steps may be added, deleted, or changed in the working flow shown in FIG. 17.

According to some embodiments, the first network device (e.g., the sharing AP such as the AP #1) may selectively communicate with the third network device (e.g., the shared AP such as the AP #2) according to the mesh protocol in advance for sending the device assignment indication to the third network device, or carry the device assignment indication in the preamble of the first data transmission frame, and the third network device may determine the SR transmission availability based on the device assignment indication, where the device assignment indication may indicate the selected network device that is scheduled to perform the SR transmission with respect to the first data transmission frame. For example, if the selected network device is equal to the third network device, the third network device may perform the SR transmission with respect to the first data transmission frame, otherwise, the third network device cannot perform any SR transmission operation with respect to the first data transmission frame. In addition, the third network device (e.g., the shared AP such as the AP #2) may control the SR transmission power based on the transmission power control indication. For example, the transmission power control indication may be arranged to indicate whether to adjust the SR transmission power as shown in Table 3, and the associated operations may comprise:
(1) when the transmission power control indication indicates that adjusting the SR transmission power is requested, the third network device (e.g., the AP #2) may configure the SR transmission power to correspond to the first predetermined power value rather than the default power value; and
(2) when the transmission power control indication indicates that adjusting the SR transmission power is not requested, the third network device (e.g., the AP #2) may configure the SR transmission power to correspond to the default power value;
but the present invention is not limited thereto. In some examples such as that shown in Table 4 and Table 5, according to the transmission power control indication, the third network device (e.g., the AP #2) may selectively keep, increase or decrease the SR transmission power. For brevity, similar descriptions for these embodiments are not repeated in detail here.

According to some embodiments, the first network device may be arranged to carry another set of link information in a preamble (e.g., a PHY preamble) of another first data transmission frame (e.g., another first PPDU) transmitted from the first network device to the second network device, where the other set of link information may comprise a forbidden indication regarding the SR transmission availability, for indicating that it is forbidden to perform any SR transmission operation with respect to the other first data transmission frame (e.g., the other first PPDU). In response to the existence of the forbidden indication, the third network device may be arranged to prevent performing any SR transmission operation with respect to the other first data transmission frame (e.g., the other first PPDU). More particularly, the forbidden indication may be carried by the SR field in the PHY preamble, and the aforementioned at least one indication may be carried by either the SR field or another field in the PHY preamble. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing network control in a wireless communications system, the wireless communications system comprising a first network device, a second network device and a third network device, the method comprising:
carrying a set of link information in a preamble of a first data transmission frame transmitted from the first network device to the second network device, wherein the set of link information comprises at least one indication among the following indications: a destination device indication, a device assignment indication and a transmission power control indication;
wherein the third network device is arranged to monitor wireless transmission in the wireless communications system to obtain the set of link information from the first data transmission frame, and determine spatial reuse (SR) transmission availability of the third network device based on the set of link information.

2. The method of claim 1, wherein the first network device is arranged to communicate with the third network device according to a mesh protocol in advance, for allowing the third network device to perform SR transmission during a predetermined time period, wherein the third network device receives the first data transmission frame during the predetermined time period; the at least one indication further comprises a first basic service set (BSS) color, and the third network device is arranged to detect the first BSS color carried by the first data transmission frame, for determining whether the first data transmission frame is sent from the first network device; and in response to the first BSS color being equal to a predetermined BSS color of the first network device, the third network device is arranged to perform the SR transmission with respect to the first data transmission frame.

3. The method of claim 2, wherein the third network device is arranged to perform SR transmission power control at least according to the transmission power control indication.

4. The method of claim 1, wherein the third network device is arranged to perform SR transmission at least according to the device assignment indication and perform SR transmission power control at least according to the transmission power control indication; and the first network device is arranged to monitor a packet error rate (PER) while the third network device is performing the SR transmission, for guiding the SR transmission power control with another transmission power control indication carried by another first data transmission frame according to the PER.

5. The method of claim 4, wherein the first network device is arranged to monitor the PER according to a device identifier (ID) of the second network device and a device ID of the third network device, wherein the destination device indication is arranged to indicate the device ID of the second network device, and the device assignment indication is arranged to indicate the device ID of the third network device.

6. The method of claim 4, wherein the third network device is arranged to perform the SR transmission power control according to a device identifier (ID) of the first network device and a device ID of the second network device, wherein the destination device indication is arranged to indicate the device ID of the second network device.

7. The method of claim 1, wherein the first network device is arranged to monitor a packet error rate (PER) while the third network device is performing SR transmission, for guiding SR transmission power control of the third network device with at least the transmission power control indication according to the PER.

8. The method of claim 7, wherein the at least one indication comprises the device assignment indication and the transmission power control indication, for guiding the SR transmission power control.

9. The method of claim 7, wherein the at least one indication comprises the destination device indication, the device assignment indication and the transmission power control indication, for guiding the SR transmission power control.

10. The method of claim 1, wherein the first data transmission frame is a physical layer (PHY) protocol data unit (PPDU), and the preamble is a PHY preamble of the PPDU.

11. The method of claim 10, wherein the at least one indication is carried in at least one field in the PHY preamble, and the at least one field comprises one or a combination of an SR field and another field in the PHY preamble.

12. The method of claim 1, wherein the third network device is arranged to determine the SR transmission availability based on the device assignment indication, wherein the first network device is arranged to selectively communicate with the third network device according to a mesh protocol in advance for sending the device assignment indication to the third network device, or carry the device assignment indication in the preamble of the first data transmission frame.

13. The method of claim 12, wherein the device assignment indication is arranged to indicate a selected network device that is scheduled to perform SR transmission with respect to the first data transmission frame.

14. The method of claim 13, wherein if the selected network device is equal to the third network device, the third network device is arranged to perform the SR transmission with respect to the first data transmission frame, otherwise, the third network device is prevented from performing any SR transmission operation with respect to the first data transmission frame.

15. The method of claim 1, wherein the third network device is arranged to control SR transmission power based on the transmission power control indication.

16. The method of claim 15, wherein the transmission power control indication is arranged to indicate whether to adjust the SR transmission power; and if the transmission power control indication indicates that adjusting the SR transmission power is requested, the third network device is arranged to configure the SR transmission power to correspond to a first predetermined power value instead of a default power value, otherwise, the third network device is arranged to configure the SR transmission power to correspond to the default power value.

17. The method of claim 15, wherein according to the transmission power control indication, the third network device is arranged to selectively keep, increase or decrease the SR transmission power.

18. The method of claim 15, wherein in response to the transmission power control indication indicating that adjusting the SR transmission power is requested, the third network device is arranged to adjust the SR transmission power of a second data transmission frame transmitted from the third network device to a fourth network device according to at least one adjustment control parameter.

19. The method of claim 18, wherein the at least one adjustment control parameter comprise one or a combination of an SR rate offset and an SR power offset.

20. The method of claim 1, wherein the first data transmission frame is a physical layer (PHY) protocol data unit (PPDU), and the preamble is a PHY preamble of the PPDU; and the first network device is arranged to selectively communicate with the third network device according to a mesh protocol in advance for sending the device assignment indication to the third network device, or integrate both of the device assignment indication and the transmission power control indication into an encoded indication carried by a predetermined field in the PHY preamble.

21. The method of claim 20, wherein both of the device assignment indication and the transmission power control indication are integrated into the encoded indication carried by the predetermined field in the PHY preamble; and the predetermined field comprises one or a combination of an SR field and another field in the PHY preamble, and the encoded indication is a first field value for indicating the device assignment indication and the transmission power control indication, wherein:
if the predetermined field comprises the SR field, the first field value is an SR-field value, and the SR-field value is equal to any value among multiple integer values in a predetermined interval [1, 12]; and
if the predetermined field comprises the other field or the combination of the SR field and the other field, the first field value is equal to any value among multiple integer values in the predetermined interval [1, 12] or another predetermined interval.

22. The method of claim 20, wherein the first network device is arranged to generate the encoded indication according to one or more predetermined mapping relationships, for mapping the destination device indication, the device assignment indication and the transmission power control indication to the encoded indication, to allow the third network device to obtain the destination device indication, the device assignment indication and the transmission power control indication from the encoded indication according to the one or more predetermined mapping relationships.

23. The method of claim 1, further comprising:
carrying another set of link information in a preamble of another first data transmission frame transmitted from the first network device to the second network device, wherein the other set of link information comprises a forbidden indication;
wherein according to the forbidden indication, the third network device is prevented from performing any SR transmission operation with respect to the other first data transmission frame.

24. The method of claim 23, wherein each data transmission frame among the first data transmission frame and the other first data transmission frame is a physical layer (PHY) protocol data unit (PPDU), and the preamble of said each data transmission frame is a PHY preamble of the PPDU; and the forbidden indication is carried by an SR field in the PHY preamble, and the at least one indication is carried by either the SR field or another field in the PHY preamble.

25. The second network device that operates according to the method of claim 1, wherein the second network device comprises:
a processing circuit, arranged to control operations of the second network device; and
at least one communications control circuit, coupled to the processing circuit, arranged to perform communications control, wherein the at least one communications control circuit is arranged to perform wireless communications operations with the first network device for the second network device;
wherein:
the second network device is arranged to receive the first data transmission frame carrying the set of link information in the preamble and correctly process the first data transmission frame, without being hindered by any SR transmission performed by the third network device to another network device with respect to the first data transmission frame.

26. A first network device, for performing network control in a wireless communications system, the wireless communications system comprising the first network device, a second network device and a third network device, the first network device comprising:
a processing circuit, arranged to control operations of the first network device; and
at least one communications control circuit, coupled to the processing circuit, arranged to perform communications control, wherein the at least one communications control circuit is arranged to perform wireless communications operations with the second network device for the first network device;
wherein:
the first network device is arranged to carry a set of link information in a preamble of a first data transmission frame transmitted from the first network device to the second network device, wherein the set of link information comprises at least one indication among the following indications: a destination device indication, a device assignment indication and a transmission power control indication; and
the third network device is arranged to monitor wireless transmission in the wireless communications system to obtain the set of link information from the first data transmission frame, and determine spatial reuse (SR) transmission availability of the third network device based on the set of link information.

27. A method for performing network control in a wireless communications system, the wireless communications system comprising a first network device, a second network device and a third network device, the method comprising:
monitoring wireless transmission in the wireless communications system to obtain a set of link information from a preamble of a first data transmission frame, wherein the first network device is arranged to carry the set of link information in the preamble of the first data transmission frame transmitted from the first network device to the second network device, wherein the set of link information comprises at least one indication among the following indications: a destination device indication, a device assignment indication and a transmission power control indication; and
determining spatial reuse (SR) transmission availability of the third network device based on the set of link information.

28. The third network device that operates according to the method of claim 27, wherein the third network device comprises:
a processing circuit, arranged to control operations of the third network device; and
at least one communications control circuit, coupled to the processing circuit, arranged to perform communications control, wherein the at least one communications control circuit is arranged to perform wireless communications operations with another network device in the wireless communications system for the third network device;
wherein:
the second network device is arranged to receive the first data transmission frame carrying the set of link information in the preamble and correctly process the first data transmission frame, without being hindered by any SR transmission performed by the third network device to said another network device with respect to the first data transmission frame.
